(19) United States
(12) Patent Application Publication
(10) Pub. No.: US 2009/0002764 A1
(43) Pub. Date: Jan. 1, 2009

(54) ARRANGING GRAPHIC OBJECTS ON A PAGE WITH RELATIVE AREA BASED CONTROL

(76) Inventors: C. Brian Atkins, Mountain View, CA (US); Daniel R. Tretter, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/769,671

(22) Filed: Jun. 27, 2007

(51) Int. Cl. G06F 15/00

(52) U.S. Cl. 358/1.18

(57) ABSTRACT

In one aspect, respective target rendering sizes of graphic objects to be arranged on a page are ascertained based on a respective nominal size assigned to the graphic objects. Different candidate layouts of the graphic objects on the page are constructed. A final layout of the graphic objects is determined based on comparisons of ones of the actual rendering sizes of the graphic objects in the candidate layouts with their target rendering sizes. In another aspect, two or more different candidate assignments of respective nominal sizes to the graphic objects are determined. A respective set of one or more candidate layouts of the graphic objects on the page is constructed in accordance with each of two or more of the candidate assignments.

### CROSS-REFERENCE TO RELATED APPLICATIONS

This application also relates to the following co-pending applications, each of which is incorporated herein by reference:
U.S. patent application Ser. No. 10/675,724, filed Sep. 30, 2003;
U.S. patent application Ser. No. 10/675,823, filed Sep. 30, 2003;
U.S. patent application Ser. No. 11/127,326, filed May 12, 2005;
U.S. patent application Ser. No. 11/128,543, filed May 12, 2005;
U.S. patent application Ser. No. 10/831,436, filed Apr. 23, 2004;
U.S. patent application Ser. No. 11/126,637, filed Apr. 15, 2005;
U.S. patent application Ser. No. 11/151,167, filed Jun. 10, 2005;
U.S. patent application Ser. No. 11/069,512, filed Mar. 1, 2005;
U.S. patent application Ser. No. 10/987,288, filed Nov. 12, 2004; and
U.S. patent application Ser. No. 11/364,933, filed Mar. 1, 2006.

### BACKGROUND

Individuals and organizations are rapidly accumulating large collections of digital image content, including still images, text, graphics, animated graphics, and full-motion video images. This content may be presented individually or combined in a wide variety of different forms, including documents, catalogs, presentations, still photographs, commercial videos, home movies, and metadata describing one or more associated digital content files. As these collections grow in number and diversity, individuals and organizations increasingly will require systems and methods for organizing and presenting the digital content in their collections. To meet this need, a variety of different systems and methods for organizing and presenting digital image content have been proposed.

For example, there are several manual digital image albuming systems that enable users to create digital photo albums manually. These systems typically provide tools for organizing a collection of images and laying out these images on one or more pages. Among the common types of tools for manually creating a digital photo album are tools for selecting a subset of images in the collection that will appear on a page of an album, a graphical user interface for manually rearranging the images on the page, and basic image editing tools for modifying various characteristics, such as size and orientation, of the images that will appear in the album. Users typically find the process of generating a digital photo album using fully manual digital image albuming systems to be tedious and time consuming.

Some automated digital image albuming systems allow users to organize digital images into album pages in accordance with dates and times specified in the metadata associated with the images. These systems also typically allow users to annotate the images appearing in the digital photo album pages. Some automated digital image albuming systems provide various predefined layout templates that a user may select to create a digital photo album. In these systems, the user assigns images from the collection to various predefined image locations on a selected layout template, and the system automatically adjusts the size, placement, rotation, and framing of the images in accordance with parameters specified for the various predefined image locations on the selected template.

Some digital image albuming systems are designed to produce album pages automatically with minimal input from the user. One such system includes a page creator module and an image placement module. The page creator module assigns images in a collection to album pages based on a first genetic evolution algorithm. The image placement module generates genetic structures of page layouts for images that are assigned to a given page based on a second genetic evolution algorithm. These genetic structures define the locations, scales, and rotational orientations of the images that are placed on a given page. A layout evaluation module compares these layouts with certain other preferences and page requirements. When a suitable layout has been generated, the final album layout may be displayed, printed, or otherwise transferred for subsequent utilization.

Another automatic digital image albuming system includes a page layout module that presents to a user an album that is organized by event and is laid out automatically based on a set of albuming parameters. The number of images that are laid out on a page is determined by a parametric method or by an analysis of the attributes of the images. The parametric method divides a page into a set of grid squares and determines the number of images to be laid out on the page based on a set of rules for laying out images on the grid squares. In this system, the actual layout of images on a page also may be determined by matching attributes of the images, such as their sizes, to a set of templates.

Another automatic digital image albuming system automatically positions images on a page based on a force model that assumes that each image imposes a force on other images located on the same page. The force is a function of the distance separating the images. The system modifies an initial layout of images on the page by moving each image in a direction of the net force acting on the image by a distance that is a function of the net force.

What is needed are systems and methods of automatically arranging graphic objects on a page that are capable of being guided or controlled by explicit preferences for the relative sizes of one or more of the graphic objects in each layout.

### SUMMARY

In one aspect, the invention features a method of arranging graphic objects on a page. In accordance with this method, for each of the graphic objects, a respective target rendering size of the graphic object on the page is ascertained based on a respective nominal size assigned to the graphic object. Different respective candidate layouts of ones of the graphic objects on the page are constructed. In this process, respective actual rendering sizes of the graphic objects on the page in each of the candidate layouts are calculated. A final layout of the graphic objects on the page is determined based at least in part on comparisons of ones of the actual rendering sizes with respective ones of the target rendering sizes. The final layout of graphic objects is outputted.

In one aspect, the invention features a method of arranging graphic objects on a page. In accordance with this method, two or more candidate assignments of respective nominal sizes to the graphic objects are determined. Each of the candidate assignments is different from other ones of the candidate assignments. A respective set of one or more candidate layouts of the graphic objects on the page is constructed in accordance with each of two or more of the candidate assignments. One or more of the candidate layouts are outputted.

Other features and advantages of the invention will become apparent from the following description, including the drawings and the claims.

### DESCRIPTION OF DRAWINGS

FIG. 1 is a diagrammatic view of a layout of graphic objects on a page.

FIG. 2 is a diagrammatic view of the graphic object layout shown in FIG. 1 in which a multi-element graphic object that is formed from constituent single-element graphic objects is identified by a dashed ellipse.

FIG. 3A-3D are diagrammatic views of four presentations of a multi-element graphic object formed from six constituent graphic objects.

FIG. 4 is a block diagram of an embodiment of a system for arranging graphic objects on one or more pages.

FIG. 5 is a flow diagram of an embodiment of a graphic object arrangement method implemented by the system of FIG. 4.

FIG. 6 is a diagrammatic view of an embodiment of a page register that includes an assignment of respective nominal sizes and respective aspect ratios to graphic objects that are to be arranged on a page.

FIG. 7 is a flow diagram of an embodiment of a method of arranging graphic objects on a page.

FIG. 8 is a diagrammatic view of a user interface for interactively browsing different layouts of graphic objects on a page.

FIG. 9 is a diagrammatic view of a user interface presenting a selected candidate arrangement of the graphic objects in a main window and presenting alternative arrangements of the graphic objects in a side window.

FIG. 10 is a diagrammatic view of the user interface of FIG. 8 presenting a user-selected one of the alternative arrangements of the graphic objects in the main window.

FIG. 11 is a flow diagram of an embodiment of a method of generating one or more arrangements of graphic objects on a page based on one or more assignments of respective nominal sizes to the graphic objects.

FIG. 12 is a flow diagram of an embodiment of a method of generating candidate assignments of respective nominal sizes to the graphic objects that are to be laid out on a page.

FIG. 13A is a diagrammatic view of a sequence of graphic objects.

FIG. 13B is a diagrammatic view of a distribution of the graphic objects shown in FIG. 13A across a set of predetermined object type classes.

FIG. 13C is a diagrammatic view of an embodiment of method of generating a sequence of graphic objects based on the graphic object distribution shown in FIG. 13B.

FIG. 13D is a diagrammatic view of a sequence generated from the graphic objects shown in FIG. 13A in accordance with the method shown in FIG. 13C.

FIGS. 14A-16B are diagrammatic views of embodiments of candidate assignments of respective nominal sizes to the graphic objects in the sequence shown in FIG. 13D.

FIG. 17 is a flow diagram of an embodiment of a method of generating candidate assignments of respective nominal sizes to graphic objects.

FIG. 18 is a flow diagram of an embodiment of a method of comparing assignments of respective nominal sizes to graphic objects.

FIG. 19A is diagrammatic view of a distribution of the nominal sizes assigned to the graphic objects shown in FIG. 13B across the set of predetermined object type classes.

FIG. 19B is diagrammatic view of a distribution of the nominal sizes assigned to the graphic objects shown in FIG. 19A, where the nominal sizes in each object type class are sorted by magnitude.

FIG. 20 is a block diagram of an embodiment of a system for arranging graphic objects on one or more pages.

FIG. 21 is a flow diagram of an embodiment of a method of arranging graphic objects on pages.

FIG. 22 is a diagrammatic view of a partition of a page and a hierarchical tree structure corresponding to the page partition.

FIGS. 23A and 23B are flow diagrams of embodiments of methods of evaluating a layout of graphic objects on a page.

FIG. 24 is a flow diagram of an embodiment of a method of determining feasibility of paths through a tree structure.

FIG. 25 is a flow diagram of an embodiment of a method of generating a set of paths through relative layouts of graphic objects on a page.

FIGS. 26A-26J show sets of paths generated in accordance with the method of FIG. 25 with respect to an exemplary candidate relative layout.

FIG. 27 is a flow diagram of an embodiment of a method of characterizing a bounding box of a node of a tree structure.

FIG. 28 is a flow diagram of an embodiment of a method of generating an initial arrangement of graphic objects on a page.

FIGS. 29A-29C are diagrammatic views of different partitions of a page and corresponding hierarchical tree structures.

FIG. 30A is a diagrammatic view of a presentation of a first graphic object and a tree structure describing the presentation.

FIG. 30B is a diagrammatic view of a presentation of a second graphic object and a tree structure describing the presentation.

FIG. 30C is a diagrammatic view of a coarse tree structure containing leaf nodes corresponding to the first and second graphic objects shown in FIGS. 30A and 30B and a corresponding refined tree structure derived from the coarse tree structure.

FIG. 30D is a relative layout of graphic objects on a page corresponding to the coarse and refined tree structures shown in FIG. 30C.

FIGS. 31A and 31B are respective flow diagrams of first and second portions of an embodiment of a method of generating a layout of graphic objects on a page.

FIG. 32 is a flow diagram of an embodiment of a method of assigning a region of page space to a root node of a tree structure.

FIG. 33 is a flow diagram of an embodiment of a method of allocating regions of page space to children of a node of a tree structure.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. Introduction

The embodiments that are described in detail herein provide ways to arrange graphic objects on one or more pages. These embodiments are capable of being guided or controlled by explicit preferences for the relative sizes of one or more of the graphic objects in each layout (or arrangement). Some embodiments leverage this feature in order to generate alternative arrangements that give special prominence to (i.e., feature) different ones of the graphic objects. In this way, these alternative arrangements provide a sampling of layouts that spans a distribution of the possible arrangements of the graphic objects on a page. Some embodiments leverage this feature to enable a user to input preferences for the relative sizes of one or more graphic objects, where the relative size preferences is guide the layout generation process to emphasize (e.g., make larger) or de-emphasize (e.g., make smaller) certain ones of the graphic objects in a particular layout. In this way, users are able to guide the system to a particular layout of the graphic objects that meets the aesthetic preferences of the user, even when the user does not have a specific arrangement of the graphic objects in mind.

As used herein, the term “page” refers to any type of discrete area in which graphic objects may be laid out, including a physical page embodied by a discrete physical medium (e.g., a piece of paper) on which a layout of graphic objects may be printed, and a virtual, digital or electronic page containing a layout of graphic objects that may be presented to a user by, for example, an electronic display device.

The term “graphic object” refers broadly to any type of visually perceptible content that may be rendered on a physical or virtual page, including images and text. Image-based graphic objects (or simply “images”) may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image. The term “graphic object” encompasses both a single-element graphic object and a multi-element graphic object formed from a cohesive group or collection of one or more graphic objects. The assignment of single-element graphic objects to a particular multi-element graphic object signifies that the constituent single-element graphic objects are related. In general, the type of single-element graphic objects in a multi-element graphic object may be the same or different.

In some implementations, image-based graphic objects (e.g., images, such as photographs) may be designated as fixed-area images or variable-area images. In these implementations, the areas or sizes of the fixed area images are not changed in the generated layouts, whereas the sizes of the variable-area images are permitted to change. Variable-area images may or may not have constraints associated with the relative areas of images rendered on the same page.

In the illustrated embodiments, each of the image-based graphic objects is assigned a respective aspect ratio. The aspect ratio is defined as the ratio of image height to image width. Each variable-area image may further be assigned a respective positive scalar-valued nominal size. The term “nominal size” refers to a designated or theoretical size that may or may not vary from the actual or rendered size. The “size” of a graphic object refers to the amount of area of a page that is occupied by the graphic object. In some embodiments, the user is allowed to set the nominal size values that are assigned to the images. In other embodiments, the graphic object arrangement system automatically assigns the nominal size values to the graphic objects.

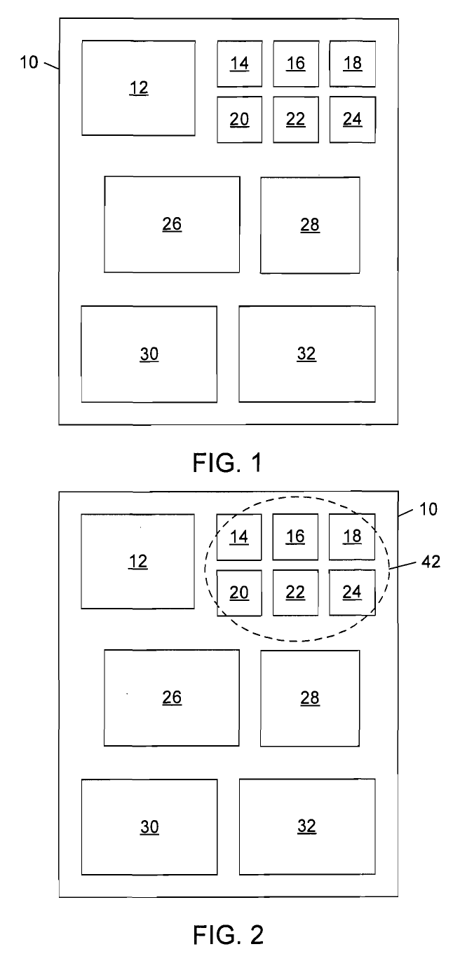

FIG. 1 shows an exemplary page 10 that includes multiple single-element graphic objects 12-32.

As shown in FIG. 2, selected ones of the single-element graphic objects 12-32 may be grouped into a graphic object 42 whose constituent graphic objects (i.e., 14-24) are intended to appear near one another in a layout of the graphic objects on a page. In the example shown in FIG. 2, the multi-element graphic object 42 may include different types of single-element graphic objects (e.g., image-based graphic objects and textual graphic objects). In addition, the single-element graphic objects of a multi-element graphic object may be arranged arbitrarily or in a specific ordered sequence (e.g., a temporally ordered sequence of keyframes of a video clip). A single-element graphic object that does not have a cohesive relationship with any other graphic object is a “degenerate” graphic object that has only one presentation.

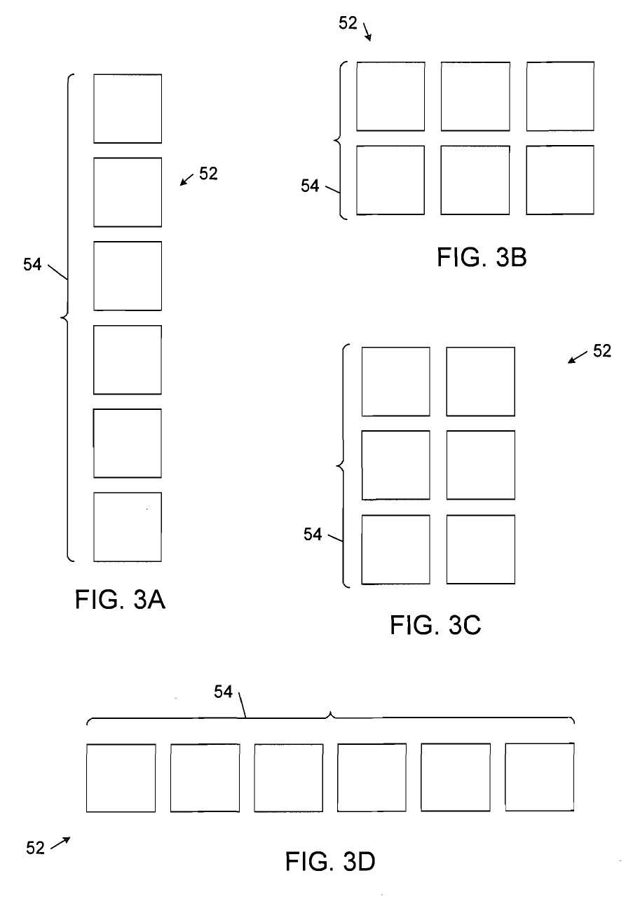

As shown in FIGS. 3A-3D, a graphic object 52 having more than one constituent graphic object may be presented (or arranged) in more than one way. In some implementations, the presentations of single-element graphic objects in a multi-element graphic object are limited to horizontal and vertical arrangements of the graphic objects. In some of these implementations, the presentations may be further limited to certain preferred horizontal and vertical arrangements of the single-element graphic objects. For example, one implementation only permits presentations in which textual graphic objects appear only to the right of or below the images in the same multi-element graphic object. In this case, a graphic object that includes an image and a text block may be presented in two different ways. FIGS. 3A-3D show that the graphic object 52, which includes a sequence 54 of six graphic objects (e.g., video keyframes), may be presented in the four different ways.

In general, graphic objects may be laid out on a page in accordance with a “strict area” style or a “brick” style. In a strict area style layout, the relative areas of graphic objects on the same page may meet pre-specified proportions. For example, a user may specify that all graphic objects on the same page have the same area. In a brick style layout, the relative areas of graphic objects on the same page are selected so that there is no empty space between images. Additional details regarding strict area style layouts and brick style layouts may be obtained from U.S. patent application Ser. No. 10/675,724, filed Sep. 30, 2004, and U.S. patent application Ser. No. 10/675,823, filed Sep. 30, 2004.

### II. General Framework for Arranging Graphic Objects on Pages

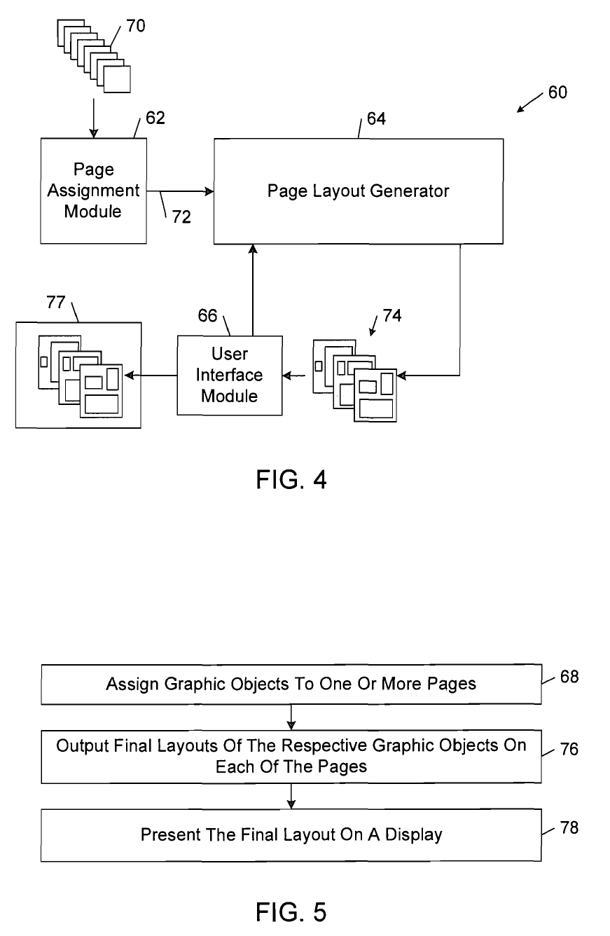

FIG. 4 shows an embodiment of a system 60 for arranging graphic objects 70 on one or more pages that includes a page assignment module 62, a page layout generator module 64, and a user interface module 66 through which a user interacts with the graphic object arrangement system 60. In general, the modules 62-66 of the graphic object arrangement system 60 are not limited to a specific hardware or software configuration, but rather they may be implemented in any computing or processing environment, including in digital electronic circuitry or in computer hardware, firmware, device driver, or software. For example, in some implementations, these modules may be embedded in the hardware of any one of a wide variety of digital and analog electronic devices, including desktop and workstation computers, digital still image cameras, digital video cameras, printers, scanners, and portable electronic devices (e.g., mobile phones, laptop and notebook computers, and personal digital assistants). In some implementations, computer process instructions for implementing the modules 62-66 and the data generated by the modules 62-66 are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and CD-ROM.

FIG. 5 shows an embodiment of a method by which the page assignment module 62 and the page layout generator module 64 cooperatively generate a respective layout of graphic objects on each of one or more pages.

The page assignment module 62 assigns graphic objects to one or more pages (FIG. 5, block 68). The page assignment module 62 operates on a collection of graphic objects 70, which may be designated by the user or may be identified automatically by the graphic object arrangement system 60. The page assignment module 62 assigns the graphic objects 70 to the one or more pages using any one of a wide variety of page assignment methods. In some approaches, the page assignment module 62 assigns the graphic objects 70 to pages based on a page-filling criterion, such as a user-specified or default maximum number of graphic objects 70 that may be laid out on a page, or a user-specified or default fixed number of pages. In these approaches, the page assignment module 62 may assign the graphic objects 70 to pages in accordance with one or more arrangement criteria, such as a user-specified arrangement of graphic objects or a default arrangement rule that is specified in terms of metadata that is associated with the graphic objects 70. For example, the page assignment module 62 may assign graphic objects 70 to pages chronologically based on date and time metadata that is associated with the graphic objects 70. Alternatively, the page assignment module 62 may assign graphic objects 70 to pages based on an event-based analysis of the graphic objects 70. The page assignment module 62 passes graphic object page assignment data 72, which specifies the assignments of the graphic objects 70 to the pages, to the initial layout generator module 64.

The page layout generator module 64 outputs final or determinate layouts 74 of the respective graphic objects on each of the pages in accordance with the graphic object assignment data 72 (FIG. 5, block 76). As used herein, the terms “determinate layout” and “final layout” are used synonymously to refer to a layout of graphic objects on a page in which the positions and dimensions of the graphic objects are specified. In some embodiments, the page layout generator module 64 determines a final layout for a given one of the pages based on a scoring, evaluation, or fitness function that promotes the production of final layouts in which the sizes of the graphic objects are closer to the nominal sizes assigned to the graphic objects. Such a scoring, evaluation, or fitness function may be utilized in a wide variety of different layout generation embodiments, as described in detail below. In some implementations, the page layout generator module 64 outputs the final layouts 74 in the form of a specification that is arranged in a particular file format (e.g., PDF or XML).

The page layout generator module 64 outputs the final layouts 74 of the graphic objects 70 on the one or more pages to the user interface module 66, which presents (or renders) the final layouts on a display 77 (FIG. 5, block 78). In some implementations, the user interface module 66 allows a user to interactively browse the pages that are generated automatically by the graphic object arrangement system 60. The user interface module 66 also allows a user to specify edits to the pages. Any specified edits to a given page are interpreted by the user interface module 66. The user interface module 66 transmits the interpreted user command instructions to the page layout generator module 64. The page layout generator module 64 repeats one or more aspects of the method of FIG. 5 to determine revised final layouts 74 of one or more pages in accordance with the edits received from the user interface module 66. The user interface module 66 presents the revised final layouts 74 to the user. The user then may browse the revised pages, specify edits to the one or more revised pages, or command the system 60 to render some or all of the pages.

III. Arranging Graphic Objects on a Page with Relative Area Based Control

A. Introduction

As explained in detail below, the page layout generator module 64 is capable of being guided or controlled by explicit preferences for the relative sizes of one or more of the graphic objects in each page layout. This feature enables a user to input preferences for the relative sizes of one or more graphic objects, where the relative size preferences cause the page layout generator module 64 to emphasize (e.g., make larger) or de-emphasize (e.g., make smaller) certain ones of the graphic objects in a particular layout in accordance with the user's preferences. This allows users to guide the system to a particular layout of the graphic objects that meets the aesthetic preferences of the user, even when the user does not have a specific arrangement of the graphic objects in mind. In some embodiments, the page generator module 64 uses the explicit preferences for the relative sizes of one or more of the graphic objects to generate a sampling of alternative layouts that span a wide distribution of the possible arrangements of the graphic objects on a page by giving special prominence to different ones of the graphic objects. This feature allows users to rapidly browse a wide variety of different page layouts before selecting a final layout for rendering.

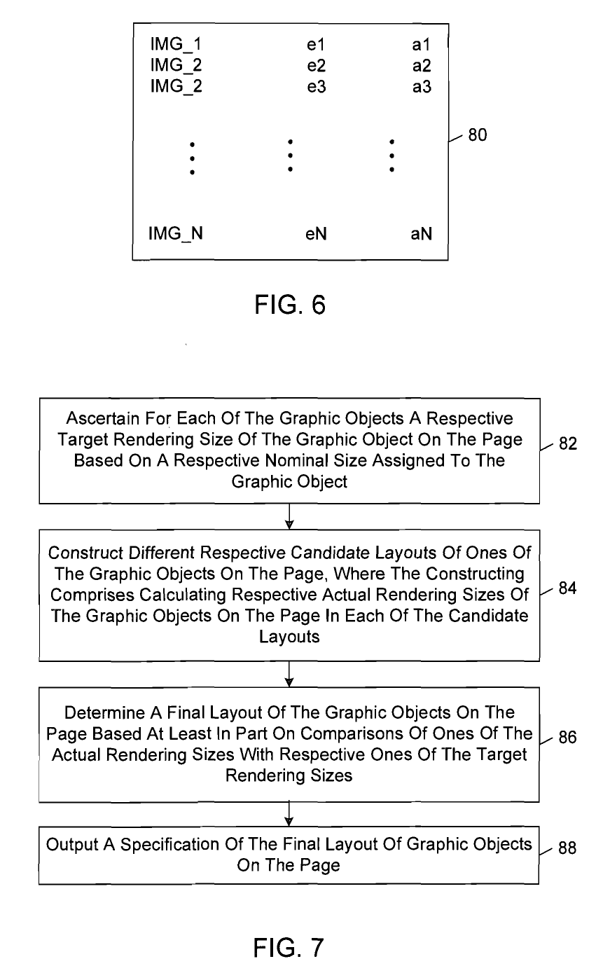

Referring to FIG. 6, the page layout generator module 64 generates the final page layouts 74 based on the page assignment data 72 produced by the page assignment module 62 (see FIG. 4) and a respective page register that specifies each page. In the illustrated embodiments, each page is specified by a page register 80 that includes a list of the graphic objects (e.g., IMG_1, IMG_2, . . . , IMG_N) that are scheduled to be arranged on the page and an assignment of a respective aspect ratio value (e.g., a1, a2, . . . , aN) and a respective nominal size value (e.g., e1, e2, . . . , eN) to each of the graphic objects in the list. As explained above, the aspect ratio of an image-based graphic object (e.g., an image) is defined as the ratio of the height of the graphic object to its width. The nominal size values (e.g., e1, e2, . . . , eN) may be set by the user or the graphic object arrangement system 64. The visual appearance of any particular layout of a set of graphic objects on a page is determined by the associations between the aspect ratio values and the nominal size values specified in the page register for that page, where different associations between the aspect ratio values and the nominal size values typically result in the production of page layouts that have different visual appearances.

B. Generating Page Layouts with Relative Area Control

1. Overview

FIG. 7 shows an embodiment of a method in accordance with which the page layout generator module 64 arranges a set of graphic objects on a page in a way that enables it to be guided or controlled by explicit preferences for the relative sizes of one or more of the graphic objects in each layout (or arrangement).

In accordance with the method of FIG. 7, the page layout generator module 64 ascertains for each of the graphic objects a respective target rendering size of the graphic object on the page based on a respective nominal size assigned to the graphic object (FIG. 7, block 82). In some embodiments, the page layout generator module 64 sets the target rendering size (tᵢ) for each graphic object i to a fraction of a total area of the page allocated for arranging the graphic objects (A_{ALLOCATED}) that is equal to a ratio of the respective nominal size (eᵢ) to a sum of the respective nominal sizes assigned to all N of the graphic objects to be arranged on the page. That is,

$${t}_{i} = \frac{{e}_{i}}{{\sum }_{j = 1}^{N} {e}_{j}} \cdot {A}_{ALLOCATED} \qquad ( 1 )$$

The page layout generator module 64 constructs different respective candidate layouts of ones of the graphic objects on the page (FIG. 7, block 84). In this process, the page layout generator module 64 calculates respective actual rendering sizes of the graphic objects on the page in each of the candidate layouts. As explained in detail below, the different candidate layouts may be constructed in a wide variety of different ways, including but not limited to tree structure based page partitioning approaches and genetic algorithm based graphic object arrangement approaches.

The page layout generator module 64 determines a final layout of the graphic objects on the page based at least in part on comparisons of ones of the actual rendering sizes with respective ones of the target rendering sizes (FIG. 7, block 86). In some embodiments, the page layout generator module 64 determines a final layout for a given page based on a scoring, evaluation, or fitness function that promotes the production of final layouts in which the sizes of the graphic objects are closer to the nominal sizes assigned to the graphic objects. Such a scoring, evaluation, or fitness function may be incorporated into a wide variety of different page layout generation systems, as described in detail below.

After the final layout of the graphic objects has been determined (FIG. 7, block 86), the page layout generator module 64 outputs the final layout of graphic objects (FIG. 7, block 88). The page layout generator module 64 may output the final layout in the form of a specification that includes a data structure (e.g., a table or a list) that describes the final page layout. In some embodiments, the specification is stored on a machine-readable medium in an XML (eXtensible Markup Language) file format. Storage devices suitable for tangibly embodying specification include all forms of non-volatile computer-readable media and volatile computer-readable media, including but not limited to, for example, semiconductor memory devices, such as EPROM, EEPROM, and flash memory devices, magnetic disks such as internal hard disks and removable disks, magneto-optical disks, and CD-ROMs. The final layout specification may be used by the user interface module 66 or a print module to render the final layout on a display or a print medium (e.g., paper).

2. Exemplary Types of Page Layout Generator Modules Configured for Relative Area Control

In general, the page layout generator module 64 may determine a final layout of the graphic objects on a given page in a wide variety of different ways.

In some embodiments, the page layout generator module 64 determines a final layout for a given page using a tree structure based partitioning of each page. In this process, the page layout generator module 64 iteratively constructs a series of successive layouts each of which includes an additional one of the graphic objects added to the preceding layout in the series. In each of the iterations, the page layout generator module 64 constructs a current one of the successive layouts from the preceding successive layout based on respective scores. The scores are calculated from comparisons of ones of the actual rendering sizes with respective ones of the target rendering sizes that are computed for candidate current layouts defined by different respective relative positions of the additional graphic object in the preceding successive layout. Additional details regarding the structure and operation of the tree structure based page partitioning embodiments are contained in section IV below.

In other embodiments, the page layout generator module 64 determines a final layout for a given page by evolving a respective genetic structure that defines the locations, scales, and rotational orientations of the graphic objects that are placed on the given page in accordance with a genetic algorithm and selecting a final layout from the resulting layouts based on the above-mentioned scoring, evaluation, or fitness function, along with certain preferences and page requirements. Additional details regarding the structure and operation of the genetic evolution based graphic object arrangement embodiments are contained in, for example, U.S. Pat. No. 6,636,648 and U.S. Patent Application Publication No. 2002/0122067.

In other embodiments, the page layout generator module 64 determines a final layout for a given page by positioning images on a page based on a force model that assumes that each image imposes a force on other images located on the same page. The force is a function of the distance separating the images. Each image is moved in a direction of the net force acting on the image by a distance that is a function of the net force. Additional details regarding the structure and operation of the force model based graphic object arrangement embodiments are contained in, for example, U.S. Pat. No. 6,636,650.

Regardless of the type of graphic arrangement model that is used, each embodiment of the page layout generator module 64 determines a final page layout for a given set of graphic objects based on a scoring, evaluation, or fitness function that promotes the production of final layouts in which the sizes of the graphic objects are closer to the nominal sizes assigned to the graphic objects. In some embodiments, the page layout generator module 64 calculates for each of the candidate layouts a respective layout score based on degrees to which actual rendering sizes of the graphic objects in the candidate layout match the respective target rendering sizes. The scoring function typically incorporates a metric that provides an indication of how close the actual sizes of the graphic objects in a given layout are to their assigned nominal sizes. In some of these embodiments, the page layout generator module 64 calculates a respective graphic object score for each of the graphic objects in each of the candidate layouts based on a ratio of the actual rendering size to the respective target rendering size. The page layout generator module 64 calculates for each of the candidate layouts a respective layout score from the respective graphic object scores.

In one exemplary embodiment, a layout score (layout_score) is calculated for a given candidate page layout in accordance with the following pseudo code:

```
layout_score = S_{INITIAL};
group_multiplier = M_{INITIAL};
For each photo {
    ratio = actual_area / target_area
    graphic_object_score = 1.0;
    if ( ratio < σ₁ ) {
      graphic_object_score = ratio / σ₁
      if ( ratio < σ₂ ) {
        graphic_object_score = (graphic_object_score)²;
      }
    }
    if ( graphic_object_score < δ_{T} ) {
      group_multiplier = group_multiplier * θ_{PENALTY};
    }
    layout_score = layout_score + graphic_object_score;
}
layout_score = layout_score * group_multiplier
```

In this exemplary embodiment, the parameter S_{INITIAL} is an initial layout score, which typically is set to 0.0. The parameter M_{INITIAL} is an initial value for the group-multiplier variable and typically is set to 1.0. The variable “actual_area” corresponds to the actual rendering size of the graphic object in the given candidate page layout, and the variable “target_area” corresponds to the target rendering size of the graphic object ascertained in block 82 of FIG. 7. The parameter σ₁ is a first ratio threshold that has a value in the range [0,1] and that identifies graphic objects whose scores should be penalized because their respective actual areas are considered to be small in relation to their target areas. The parameter σ₂ is a second ratio threshold that has a value less than σ₁ in the range [0,1] and that identifies graphic objects whose scores should be additionally penalized because their respective actual areas are considered to be unduly small in relation to their target areas. In one exemplary implementation, σ₁=0.9 and σ₂=0.5. The parameter δ_{T} is a graphic object score threshold that identifies graphic objects whose scores are considered to be sufficiently low that the overall layout score should be penalized, which is achieved by lowering the value of the “group_multiplier” variable by an amount set by the penalty factor parameter θ_{PENALTY}. In one exemplary implementation, δ_{T}=0.25 and θ_{PENALTY}=0.8.

In these embodiments, the page layout generator module 64 typically selects the layout having the highest layout score as the final layout that is output to the user interface module 66 for presentation to the user. In some embodiments, the page layout generator module 64 stores the specifications for multiple ones of the highest scoring layouts. One or more of these layout specifications may be output to the user interface module 66 in response to a user's request to browse one or more alternative layouts.

C. Generating Alternative Layouts with Relative Area Control

1. User Interface for Browsing Graphic Object Layouts

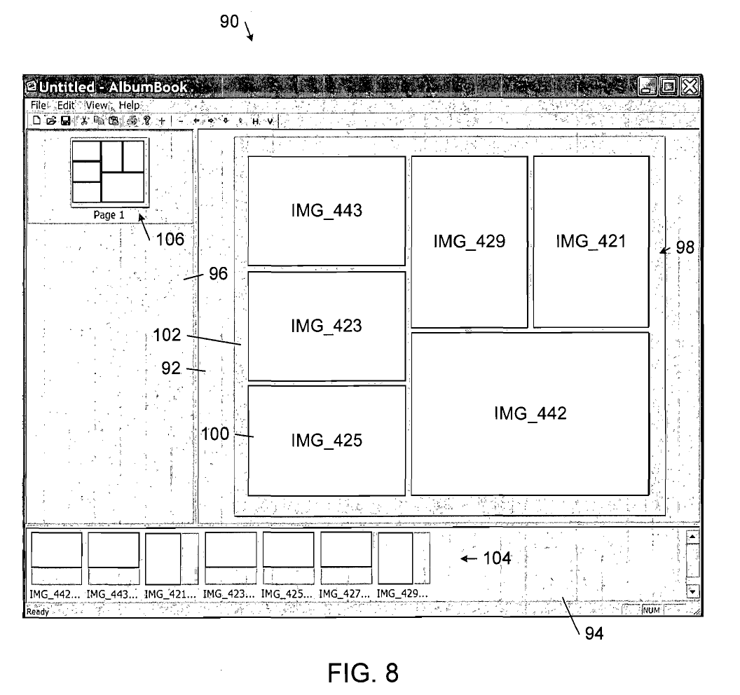

FIG. 8 shows an embodiment of a user interface 90 for interactively browsing the pages that are generated automatically by the system 60 (see FIG. 4). The user interface 90 includes a main window 92, a graphic object browsing window 94, and a layout browsing window 96. The main window 92 presents a current layout 98 of graphic objects 100 (i.e., IMG_443, IMG_429, IMG_421, IMG_423, IMG_425, and IMG_442) on a page 102. The graphic object browsing window 94 contains an array of reduced-resolution thumbnail versions 104 of the graphic objects 100. The layout browsing window 96 contains reduced-resolution thumbnail versions 106 of the current layouts of the pages of the album, which consists of a single page in the exemplary album shown in FIG. 8.

The user interface 90 provides a user with an option to submit a request for the system 60 to generate a specified number of alternative layouts of the graphic objects 100 that differ from the current layout 98 in one or more respects. The number of alternative layouts may be specified by the user; alternatively, the number of alternative layouts may be a default number. The user may input preferences for the relative sizes of one or more of the graphic objects 100 in the request for the system to generate alternative layouts. The relative size preferences guide the layout generation process in emphasizing (e.g., make larger) or de-emphasizing (e.g., make smaller) certain ones of the graphic objects in a particular layout. The page layout generator module 64 generates a number of page registers equal to the specified number of alternative layouts page in a randomized fashion as described below, or in accordance with a predefined method as described below, or in accordance with the user's preferences (if they are specified in the request). The page layouts generator 64 generates the page registers so that each page register contains a unique assignment of respective nominal sizes to the graphic objects (see, e.g., FIG. 6), as described in detail below.

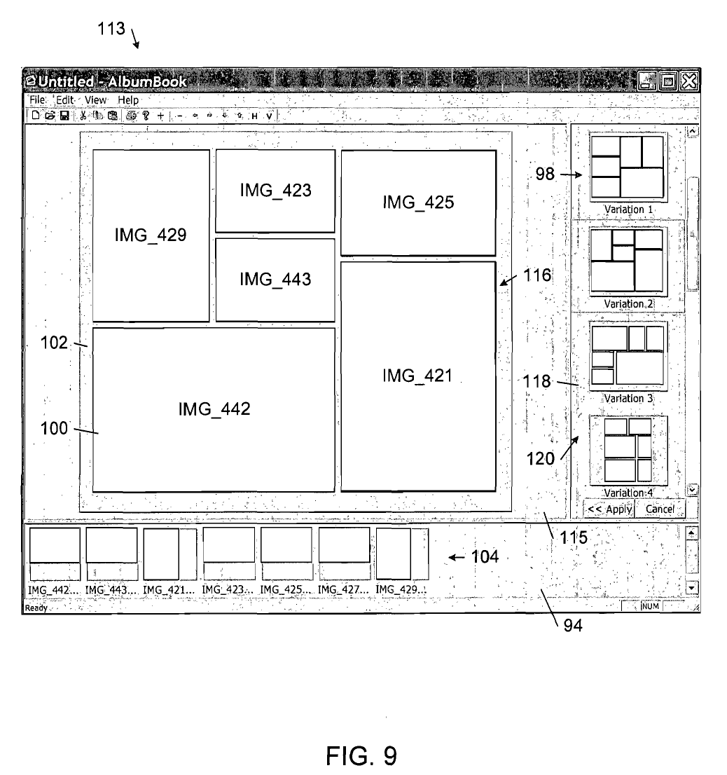

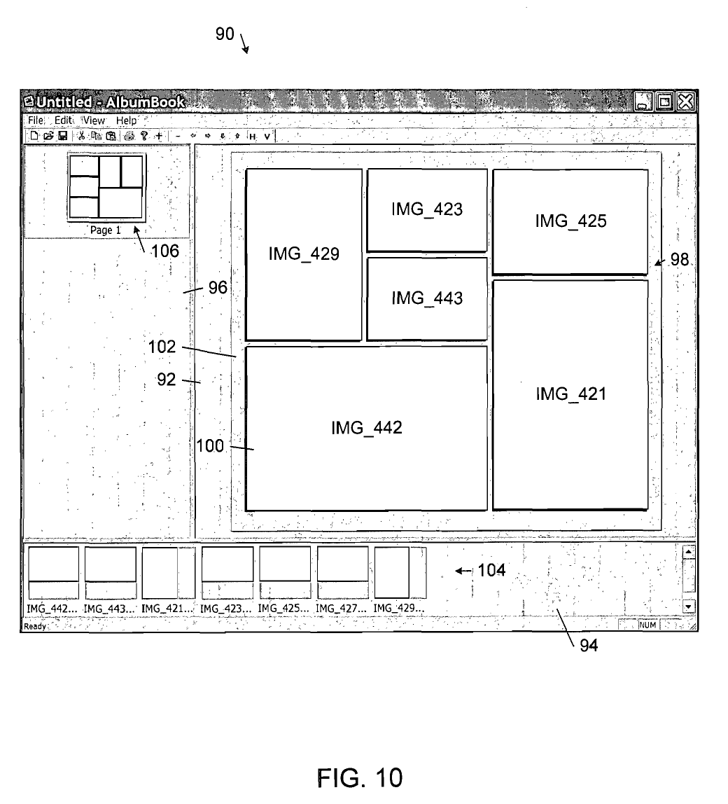

FIG. 9 shows a user interface 113 that includes a main window 115 and a side window 118. The main window 115 presents a user-selected layout 116. The side window 118 presents thumbnail images of alternative arrangements 120 of graphic objects 100 that were generated by the page layout generator module 64. The thumbnail 106 of the current layout 98 (see FIG. 8) is included at the top of the side window 118 (or “variations”), denoted “Variation 1” in FIG.9. The user may select the alternative arrangement that are presented in the main window 115 by selecting the corresponding thumbnail version 120 in the side window 118 using, for example, a pointer (e.g., a computer mouse). The user may replace the current layout 98 (see FIG. 8) that is presented in the main window of the user interface 90 with a selected one of the alternative arrangements by selecting the “<<Apply” button 122. FIG. 10 shows the user interface 90 after the user has selected the “<<Apply” button 122 while the thumbnail image (i.e., “variation 2”) of the alternative layout 116 was selected.

2. Generating Alternative Graphic Object Layouts

a. Overview

In some embodiments, the page layout generator module 64 generates alternative layouts of a given set of graphic objects in accordance with the following process steps:
1. produce a set of page registers each of which contains a unique association between the aspect ratios of the graphic objects and the nominal sizes assigned to the graphic objects;
2. generate a candidate layout for each page register; and
3. select ones of the candidate layouts that are determined to be different in one or more ways.
   The page registers that are produced in step 1 typically result in the production of different respective candidate page layouts because the alternative page registers contain unique associations between the aspect ratios and the nominal sizes of the graphic objects.

Some embodiments of the system 60 allows the user to specify that one or more of the graphic objects should be emphasized (e.g., made larger) or de-emphasized (e.g., made smaller) in the set of alternative candidate layouts. In these embodiments, the workflow described above is the same; however, the selected graphic objects will be emphasized or de-emphasized in each of the candidate layouts in accordance with the user's specified preferences. In accordance with these embodiments, the page layout generator module 64 generates alternative layouts of a given set of graphic objects in accordance with the following process steps:
1. produce a set of page registers each of which contains a unique association between the aspect ratios of the graphic objects and the nominal sizes assigned to the graphic objects and selected ones of the graphic objects are emphasized or de-emphasized in accordance with the user's preferences;
2. generate a candidate layout for each page register; and
3. select ones of the candidate layouts that are determined to be different in one or more ways and in which the selected ones of the graphic objects are emphasized or de-emphasized in accordance with the user's preferences.

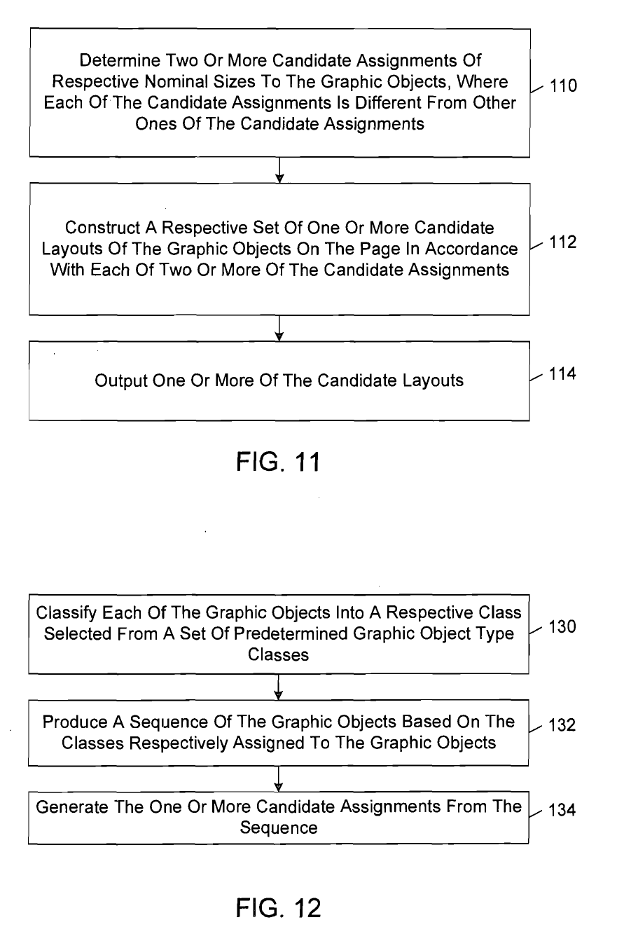

FIG. 11 shows an embodiment of a method of generating one or more alternative arrangements of graphic objects on a page.

In accordance with the method of FIG. 11, the page layout generator module 64 determines two or more candidate assignments of respective nominal sizes to the graphic objects (FIG. 11, block 110). As described in detail below, each of the candidate assignments is different from other ones of the candidate assignments.

The page layout generator module 64 constructs a respective set of one or more candidate layouts of the graphic objects on the page in accordance with each of one or more of the candidate assignments (FIG. 11, block 112). As explained above, the different candidate layouts may be constructed in a wide variety of different ways, including but not limited to tree structure based page partitioning approaches and genetic algorithm based graphic object arrangement approaches.

The page layout generator module 64 outputs one or more of the candidate layouts (FIG. 11, block 114). In some embodiments, the page layout generator module 64 outputs the ones of the candidate layouts whose layouts are determined to be different from other layouts.

b. Determining Different Candidate Assignments

There are many different ways in which the page layout generator module 64 may determine one or more candidate assignments of respective nominal sizes to the graphic objects (FIG. 11, block 110). The embodiments that are described in this section are designed to produce a set of page registers that contain candidate assignments that are likely to result in the production of different candidate layouts by the page layout generator module 64.

FIG. 12 shows an embodiment of a method of generating candidate assignments of respective nominal sizes to the graphic objects that are to be laid out on a page. In accordance with this method, the page layout generator module 64 classifies each of the graphic objects into a respective class selected from a set of predetermined graphic object type classes (FIG. 12, block 130). The page layout generator module 64 produces a sequence of the graphic objects based on the classes respectively assigned to the graphic objects (FIG. 12, block 132). In some embodiments, the sequence is designed so that different ones of the graphic objects are featured (or emphasized) in the different candidate layouts. The page layout generator module 64 generates the one or more candidate assignments from the graphic object sequence (FIG. 12, block 134).

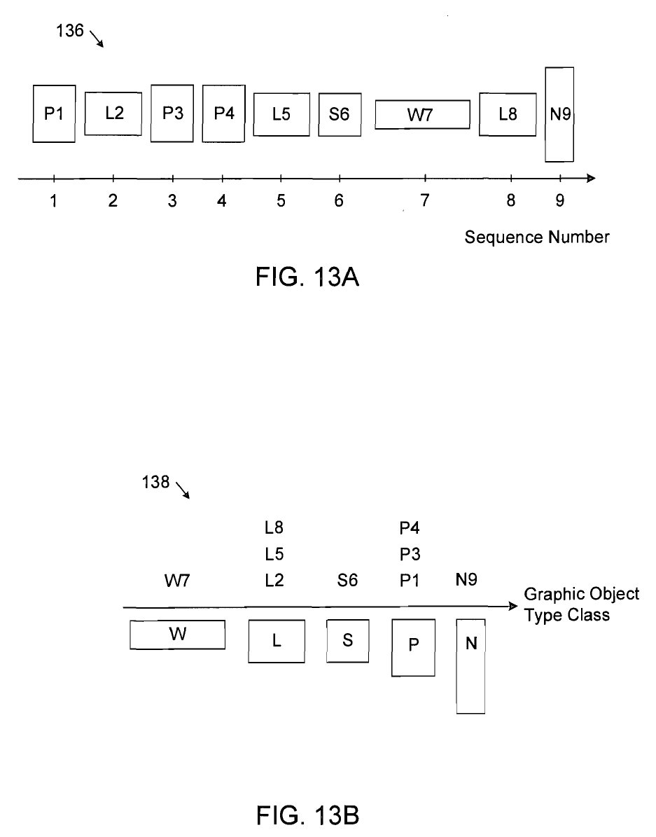

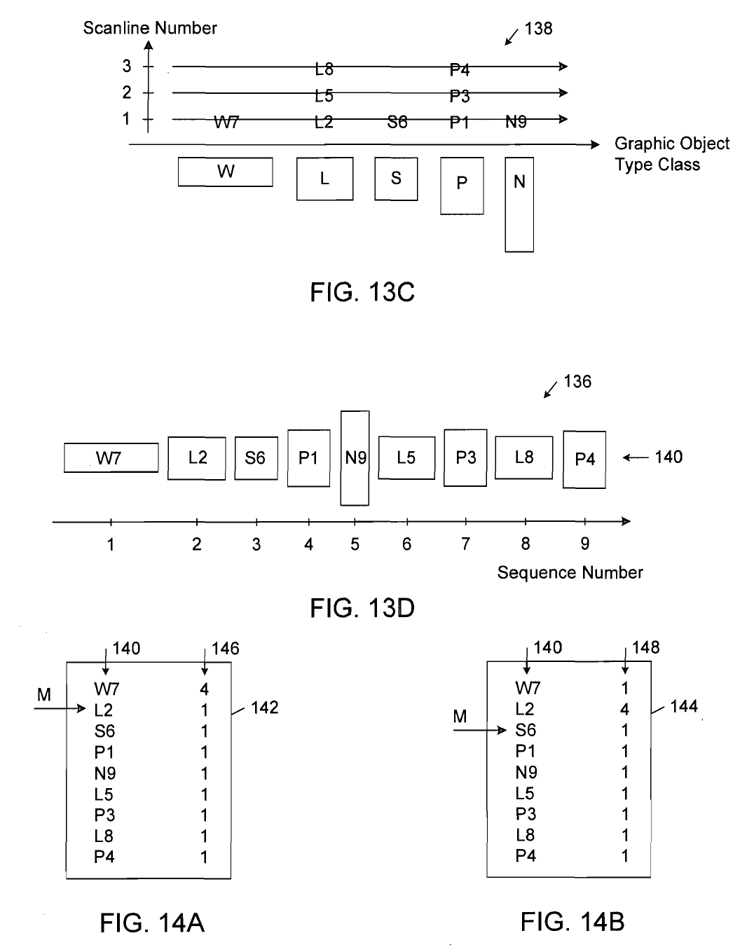

In general, the set of predetermined graphic object type classes may contain a wide variety of different graphic object type classes (see FIG. 12, block 130). In the embodiments shown in FIGS. 13A-16B, 19A, and 19B, the graphic objects are classified into respective classes selected from a portrait class (P), a landscape class (L), a square class (S), a wide landscape class (W), and a narrow portrait class (N). This type of classification is particularly suitable for classifying image-based graphic objects, such as photographs. Each of these classes is defined by the aspect ratio (i.e., height-to-width) of the graphic objects in the class. In one exemplary embodiment of this type: the portrait class (P) contains images with an aspect ratio of approximately 4:3; the landscape class (L) contains images with an aspect ratio of approximately 3:4; the square class (S) contains images with an aspect ratio of approximately 1:1; the wide landscape class (W) contains images with an aspect ratio less than 3:4; and the narrow portrait class (N) contains images with an aspect ratio greater than 4:3.

FIG. 13A shows an exemplary sequence of nine graphic objects 136 (i.e., P1, L2, P3, P4, L5, S6, W7, L8, and N9) each of which is labeled by a first character corresponding to its graphic object type class followed by a number corresponding to its sequence number. FIG. 13B shows a distribution 138 of the graphic objects 136 across the set of predetermined object type classes W, L, S, P, and N.

In general, the page layout generator module 64 may produce a sequence of the graphic objects based on the classes respectively assigned to the graphic objects in many different ways (FIG. 12, block 132). In some embodiments, the page layout generator module 64 selects successive ones of the graphic objects for the sequence from ones of the graphic object type classes that are different from the graphic object type class from which respectively preceding ones of the graphic objects were selected. For example, FIG. 13C shows one exemplary method of producing such a sequence. In this method, the page layout generator module 64 scans the distribution 138 from left-to-right in accordance with the ordered sequence of scanlines shown in FIG. 13C. The page layout generator module 64 orders the graphic objects 136 in scanline order. The resulting sequence 140 of the graphic objects 136 is shown in FIG. 13D.

The page layout generator module 64 may generate the one or more candidate assignments from the sequence 140 in a wide variety of different ways (see FIG. 12, block 134).

In some embodiments, for each graphic object type class represented in the set of graphic objects to be laid out on the page, the page layout generator module 64 generates one respective candidate assignment in which one image of that object type class is featured. In some of these embodiments, for each of represented ones of the graphic object type classes containing at least one of the graphic objects, the page layout generator module 64 generates a corresponding one of the candidate assignments in which a largest one of the nominal sizes is assigned to a respective one of the graphic objects of the corresponding represented graphic object type class. In one exemplary embodiment of this type, the page layout generator module 64 generates page registers containing respective candidate assignments in accordance with the following pseudo code (“Candidate Assignment Generation Process A”):

```
Set marker = 0
for (i = 0; i < C; i+ + ) {
    start a new “current” page register with all the graphic objects
  select the graphic object at position “marker” in the graphic object
    sequence
  marker = marker + 1
  designate the selected graphic object as “featured” on the page
  designate all other graphic objects as “not featured”
  store the designations in the current page register
  add the current page register to a list of alternative page registers
}
```

### I. Candidate Assignment Generation Process A

In this process, the variable C is the number of graphic object type classes represented by the set of graphic objects to be laid out on the page.

FIGS. 14A and 14B respectively show exemplary page registers 142, 144 containing respective assignments of nominal sizes 146, 148 to the graphic objects in the ordered sequence 140. The page register 142 is generated after the first iteration of the for-loop of the candidate assignment generation process A. The marker is positioned at the second graphic object (i.e. L2) in the sequence having been incremented during the first iteration of the for-loop of process A. The first object (W7) is featured in the page register 142 by virtue of its assignment of a nominal size of 4, whereas the remaining graphic objects are assigned a respective nominal size of 1. The page register 144 is generated after the second iteration of the for-loop of the pseudo code described above, where the marker “M” is positioned at the third graphic object (i.e., S6) in the sequence 140, its value having been incremented during the second for-loop iteration. The second object (L2) is featured in the page register 144 by virtue of its assignment of a nominal size of 4, whereas the remaining graphic objects are assigned a respective nominal size of 1.

If the number (C) of graphic object type classes represented by the set of graphic objects to be laid out on the page is greater than or equal to the number of alternative layouts requested by the calling module (e.g., the user interface 90), the page layout generation module 64 generates candidate layouts from the alternative page registers produced by candidate assignment generation process A and outputs the required number of the candidate layouts.

If the number (C) of graphic object type classes represented by the set of graphic objects to be laid out on the page is less than the number of alternative layouts requested by the calling module (e.g., the user interface 90), one or more additional candidate assignment generation processes are executed to produce a sufficient number of candidate assignments to meet the requested number of alternative layouts. In some embodiments, the candidate layout generator module 64 generates additional alternative candidate assignments in which the graphic objects are assigned respective nominal sizes selected from either a first set of one or more nominal sizes or a second set of one or more nominal sizes, where each of the nominal sizes in the second set is smaller than a smallest one of the nominal sizes in the first set. In the illustrated embodiments, the first set consists of a single nominal size of 4 and the second set consists of a single nominal size of 1. Each of the alternative candidate assignments has a different number of graphic objects that are assigned nominal sizes selected from the first set of nominal sizes. In one exemplary embodiment of this type, the page layout generator module 64 generates additional page registers containing respective candidate assignments in accordance with the following pseudo code (“Candidate Assignment Generation Process B”). In this process, N_{ADDITIONAL}=N_{REQUESTED}−N_{GENERATED}, where N_{REQUESTED} is the number of alternative layouts requested by the calling module and N_{GENERATED} is the number of candidate assignments already generated by the page layout generator module 64. Also, N is the number of photos to be placed on the page.

```
If (N_{ADDITIONAL} > N − 2)
    then {
      for (i = 2; i < N; i+ + ) {
        start a new “current” page register with all the graphic
          objects
        select the i photos at and after the at position “marker” in the
          graphic object sequence, wrapping around to the
          beginning of the sequence if necessary
    marker = (marker + i) modulo (N)
    designate the selected graphic object as “featured” on the
      page
    designate all other graphic objects as “not featured”
    store the designations in the current page register
    add the current page register to a list of alternative page
      registers
  }
}
else {
  for (i = 1; i ≦ N_{ADDITIONAL}; i+ + ) {
    start a new “current” page register with all the graphic
      objects
    x = (2*i−1) / (2* N_{ADDITIONAL})
    x = x * (N − 2)
    x = x + 2
    select the x photos at and after the at position “marker” in
      the graphic object sequence, wrapping around to the
      beginning of the sequence as necessary
    marker = (marker + x) modulo (N)
    designate the selected graphic object as “featured” on the
      page
    designate all other graphic objects as “not featured”
    store the designations in the current page register
    add the current page register to a list of alternative page
      registers
  }
}
```

### II. Candidate Assignment Generation Process B

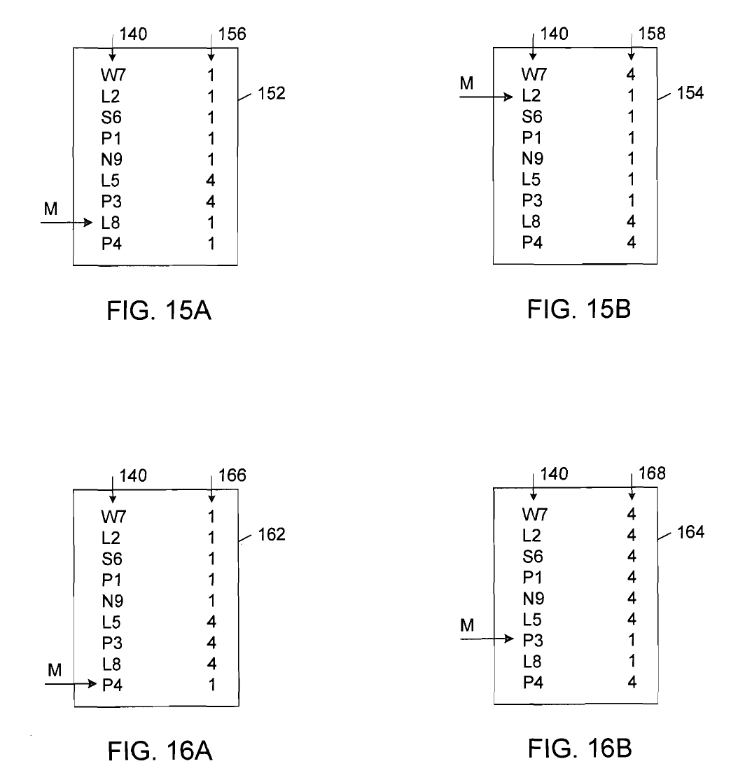

FIGS. 15A and 15B respectively show exemplary page registers 152, 154 containing respective assignments of nominal sizes 156, 158 to the graphic objects in the ordered sequence 140, assuming that immediately after Process A was completed, condition (N_{ADDITIONAL}>N−2) were true (i.e. forcing control to proceed through the first for-loop of Process B). The page register 152 is generated after the first iteration of the for-loop. The marker “M” is positioned at graphic object (i.e., L8) in the sequence 140 because at the end of Candidate Assignment Generation Process A, the marker would have been pointing to graphic object L5; and during the first for-loop iteration of Process B, its value was increased by 2. The objects L5 and P3 are featured in the page register 152 by virtue of their assignment of a nominal size of 4, whereas the remaining graphic objects are assigned a respective nominal size of 1. The page register 154 is generated after the second iteration of the first for-loop of the candidate assignment generation process B, where the marker “M” is positioned at graphic object L2 in the sequence 140. The eighth, ninth and first objects (L8, P4 and W7) are featured in the page register 154 by virtue of their assignment of a nominal size of 4, whereas the remaining graphic objects are assigned a respective nominal size of 1.

FIGS. 16A and 16B respectively show exemplary page registers 162, 164 containing respective assignments of nominal sizes 166, 168 to the graphic objects in the ordered sequence 140, assuming that immediately after Process A was completed, condition (N_{ADDITIONAL}>N−2) were false (i.e. forcing control to proceed through the second for-loop of Process B). The page register 162 is generated after the first iteration of the second for-loop of the candidate assignment generation process B, where the marker “M” is positioned at graphic object P4 in the sequence 140. The objects L5, P3 and L8 are featured in the page register 162 by virtue of their assignment of a nominal size of 4, whereas the remaining graphic objects are assigned a respective nominal size of 1. The page register 164 is generated after the second iteration of the second for-loop of the candidate assignment generation process B, where the marker “M” is positioned at graphic object P3 in the sequence 140. The objects P4, W7, L2, S6, P1, N9, and L5 are featured in the page register 164 by virtue of their assignment of a nominal size of 4, whereas the remaining graphic objects are assigned a respective nominal size of 1.

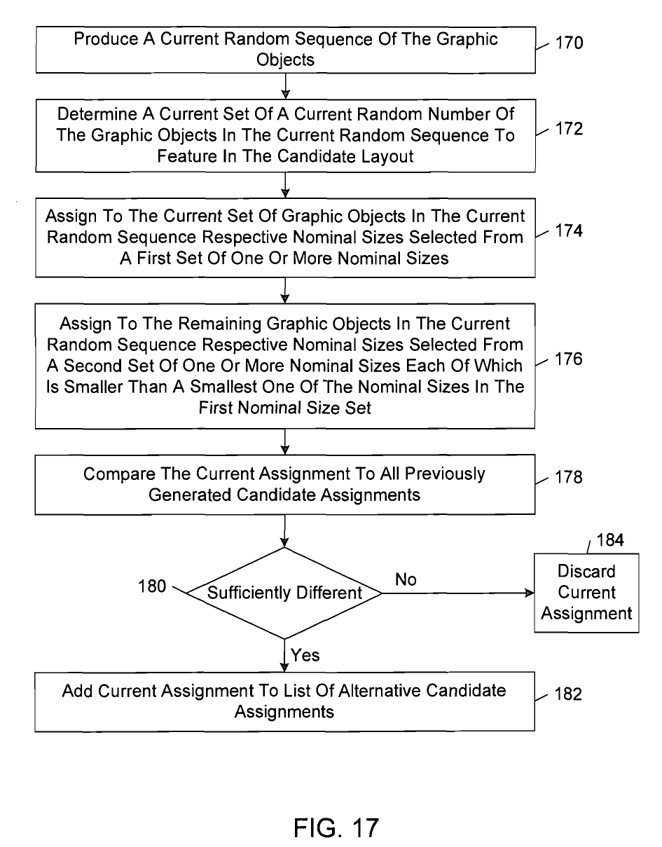

In some embodiments, if additional alternative candidate assignments are required to satisfy the requested number of alternative candidate page layouts, the page layout generator module 64 randomly generates alternative candidate assignments. For example, in some embodiments, for each of respective ones of the candidate assignments, the page layout generator module 64 assigns respective nominal sizes selected from a first set of one or more nominal sizes to a random number of a random selection of the graphic objects to be laid out on the page; the page layout generator module 64 assigns to other ones of the graphic objects respective nominal sizes selected from a second set of one or more nominal sizes. In some of these embodiments, each of the nominal sizes in the second set is smaller than a smallest one of the nominal sizes in the first set. FIG. 17 shows one exemplary embodiment of this type.

In accordance with the candidate assignment generation method of FIG. 17, a current random sequence of the graphic objects to be laid out on the page is produced (FIG. 17, block 170). A current set of a current random number (R) of the graphic objects in the current random sequence to feature in the corresponding candidate layout is determined (FIG. 17, block 172). In some embodiments, the first R graphic objects in the current random sequence are selected as the current set of graphic objects. Respective nominal sizes selected from a first set of one or more nominal sizes are assigned to the current set of graphic objects in the current random sequence (FIG. 17, block 174). Respective nominal sizes selected from a second set of one or more nominal sizes are assigned to the remaining graphic objects in the current random sequence, where each of the nominal sizes in the second set is smaller than a smallest one of the nominal sizes in the first set (FIG. 17, block 176). The current assignment is compared to all previously generated candidate assignments (FIG. 17, block 178). If the current assignment is different from all previously generated candidate assignments (FIG. 17, block 180), the current assignment is added to the list of alternative candidate assignments (FIG. 17, block 182); otherwise, if the current assignment is similar to (or not sufficiently different from) any of the previously generated candidate assignments, the current assignment is discarded (FIG. 17, block 184).

The process of FIG. 17 may be repeated until the list of alternative candidate assignments has a desired length, or until a maximum number of trials has been performed.

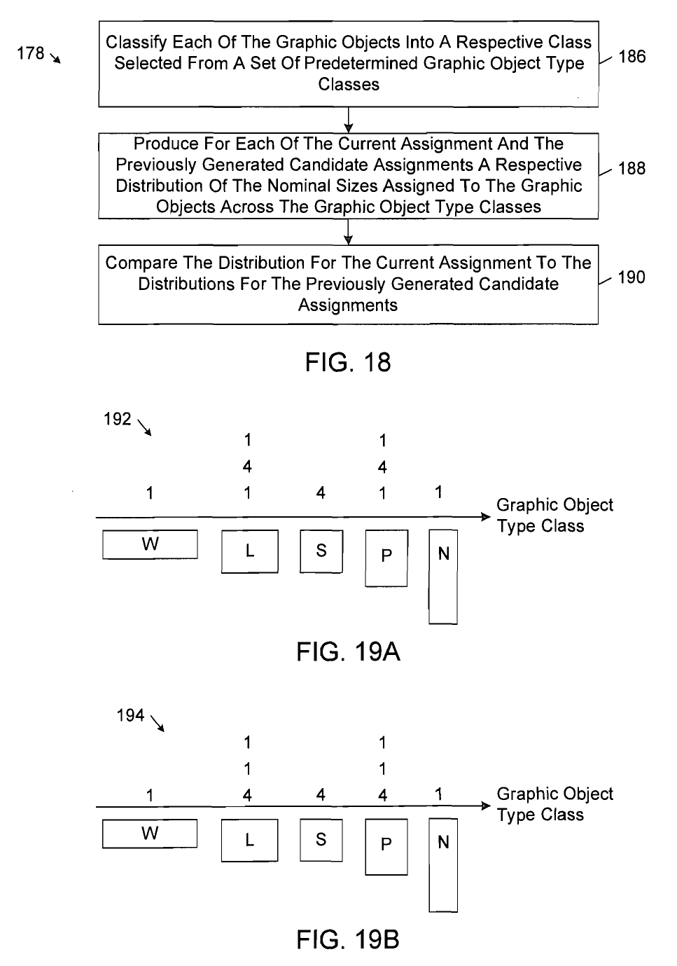

FIG. 18 is a flow diagram of an embodiment of a method of comparing assignments of respective nominal sizes to graphic objects (see FIG. 17, block 178). In accordance with this method, each of the graphic objects is classified into a respective class selected from a set of predetermined graphic object type classes (FIG. 18, block 186). For each of the current assignment and the previously generated candidate assignments, the page layout generator module 64 produces a respective distribution of the nominal sizes assigned to the graphic objects across the graphic object type classes (FIG. 18, block 188). FIG. 19A shows a distribution 192 of an exemplary set of nominal sizes that are assigned to the graphic objects 176 shown in FIG. 13B across the set of predetermined object type classes. The distribution for the current assignment is compared to the distributions produced for the previously generated candidate assignments (FIG. 18, block 190). FIG. 19B shows a distribution 194 of the nominal sizes assigned to the graphic objects shown in FIG. 19A, where the nominal sizes in each object type class are sorted by magnitude. The distribution 194 may be used as the basis for comparing assignments. For example, if two assignments have the same distribution of the type shown in FIG. 19B, they are considered to be the same; otherwise, the assignments are considered to be different.

The comparison process shown in FIG. 18 also may be used to ensure that the candidate assignments that are output from the block 134 of FIG. 12 are unique.

### IV. Exemplary Page Layout Generator Embodiments

A. Introduction

In the embodiments described in this section, the page layout generator module 64 determines a final layout for a given page using a tree structure based partitioning of each page. In this process, the page layout generator module 64 iteratively constructs a series of successive layouts each of which includes an additional one of the graphic objects added to the preceding layout in the series. In each of the iterations, the page layout generator module 64 constructs a current one of the successive layouts from the preceding successive layout based on respective scores. The scores are calculated from comparisons of ones of the actual rendering sizes with respective ones of the target rendering sizes that are computed for candidate current layouts defined by different respective relative positions of the additional graphic object in the preceding successive layout.

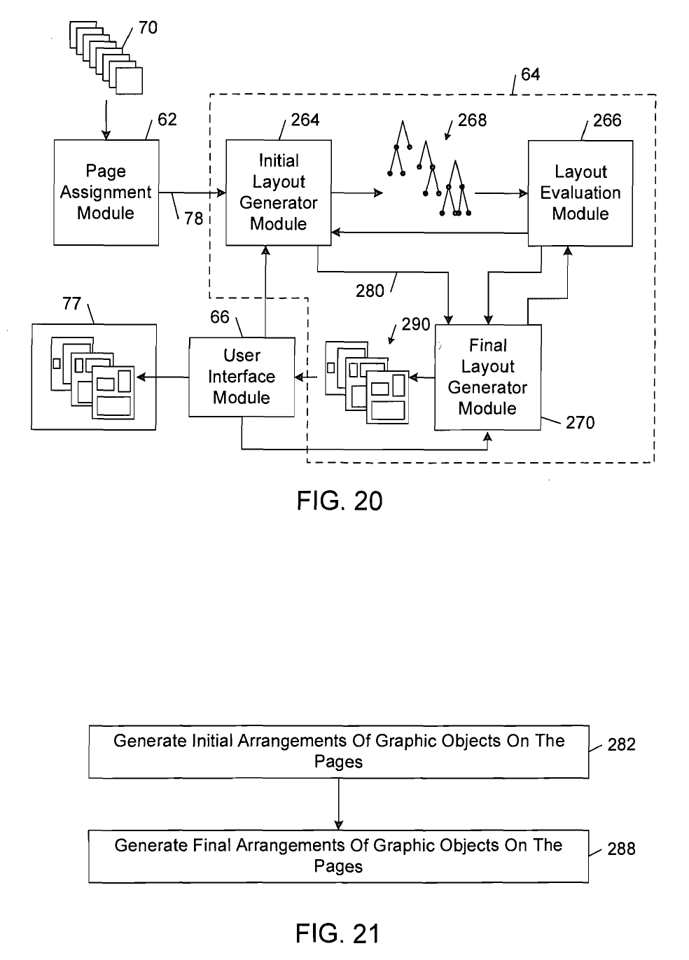

FIG. 20 shows an embodiment of the page layout generator module 64 that includes an initial layout generator module 264, a layout evaluation module 266, and a final layout generator module 270.

In general, the modules 264-270 of the page layout generator module 64 are not limited to any particular hardware or software configuration, but rather they may be implemented in any computing or processing environment, including in digital electronic circuitry or in computer hardware, firmware, device driver, or software. For example, in some implementations, these modules may be embedded in the hardware of any one of a wide variety of digital and analog electronic devices, including desktop and workstation computers, digital still image cameras, digital video cameras, printers, scanners, and portable electronic devices (e.g., mobile phones, laptop and notebook computers, and personal digital assistants). In some implementations, computer process instructions for implementing the modules 264-270 and the data generated by the modules 264-270 are stored in one or more machine-readable media. Storage devices suitable for tangibly embodying these instructions and data include all forms of non-volatile memory, including, for example, semiconductor memory devices, such as EPROM, EEPROM, and flash memory devices, magnetic disks such as internal hard disks and removable disks, magneto-optical disks, and CD-ROM.

FIG. 21 shows an embodiment of a method by which the initial layout generator module 264, the layout evaluation module 266, and the final layout generator module 270 cooperatively generate a layout of graphic objects on one or more pages.

The initial layout generator module 264 generates an initial arrangement 280 (or initial relative layout) of the graphic objects 70 on each page based on the graphic object assignment data 78 (FIG. 21, block 282). As used herein, the term “relative layout” refers to a layout of graphic objects on a page in which the relative positions of the graphic objects are specified but the absolute positions of the graphic objects are not specified. In some implementations, the initial layout generator module 264 stores the specifications of each relative page layout in a respective data structure 268 that represents a binary tree, which has leaf nodes corresponding to graphic objects and interior nodes corresponding to divisions of the corresponding page. The initial layout generator module 264 passes the initial arrangements 280 of graphic objects 70 on the pages to the final layout generator module 270.

The final layout generator module 270 generates final arrangements of graphic objects on the pages from the arrangements received from the initial layout generator module 264 (FIG. 21, block 288). In this process, the final layout generator module 270 determines respective determinate layouts 290 of the graphic objects on the one or more pages. As used herein, the term “determinate layout” or “final layout” refers to a layout of graphic objects on a page in which the positions and dimensions of the graphic objects are specified. The final layout generator module 270 outputs the final determinate layouts 290 of the graphic objects on the one or more pages to the user interface module 66.

In the processes of generating the initial arrangements 280 and the final arrangements 290 of graphic objects on the one or more pages (FIG. 21, blocks 282, 288), the initial layout generator 264 and the final layout generator module 270 generate various candidate arrangements and one set of final arrangements of graphic objects 70 on the one or more pages. The initial layout generator 264 and the final layout generator module 270 pass specifications of these arrangements to the layout evaluation module 266, which determines layout feasibility, computes various layout dimensions for the graphic objects on the pages, and computes scores for the candidate arrangements. As explained in detail below, the feasibility test results, dimensions, and scores are used by the initial layout generator 264 and the final layout generator module 270 to select the initial arrangements 80 and the final arrangements 290 of graphic objects from the various candidate arrangements that are generated.

B. Tree Structures

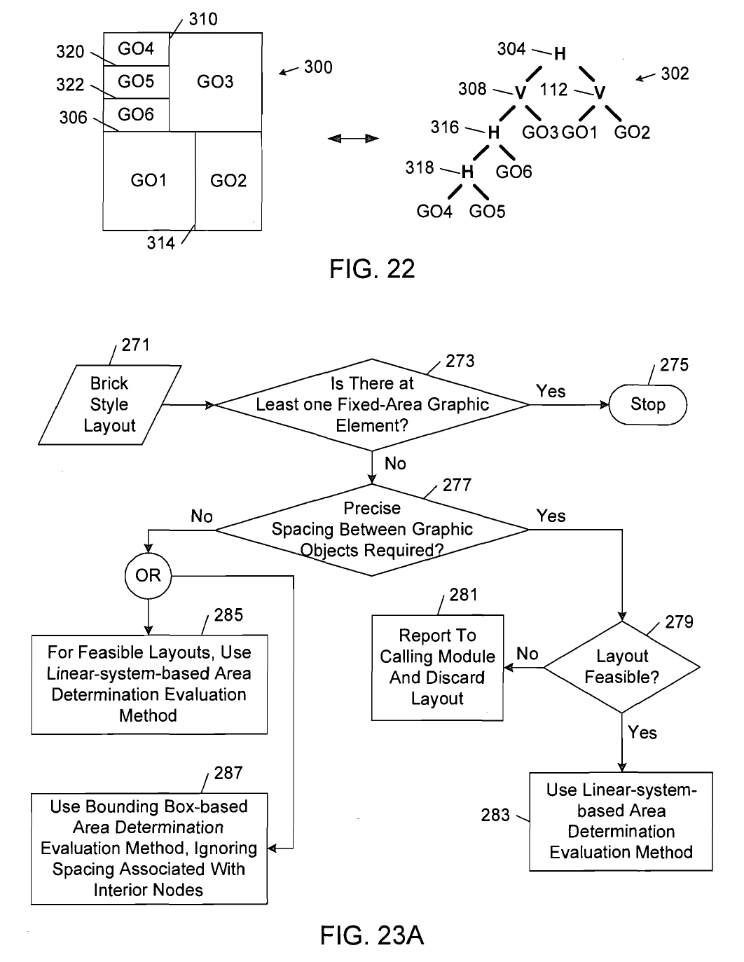

Referring to FIG. 22, the initial layout generator module 264 divides each page 300 in accordance with a respective candidate relative layout, which is represented by a corresponding tree structure 302. Each leaf node of the tree structure 302 corresponds to a respective graphic object (GO1, GO2, GO3, GO4, GO5, GO6) on the page 300. Each interior node (H, V) of the tree structure 302 corresponds to one of either a horizontal or a vertical division on the corresponding page 300. In the exemplary candidate relative layout of page 300 and the corresponding tree structure 302, the root H node 104 represents the horizontal division 306 of page 300. The left interior V node 308 represents the upper vertical division 310 of page 300, and the right interior V node 312 represents the lower vertical division 314 of page 300. The interior H nodes 316, 318 respectively represent the horizontal divisions 322, 320 of page 300. The positions of leaf nodes in the tree structure 302 specify the unique relative locations of the corresponding graphic objects (GO1, GO2, GO3, GO4, GO5, and GO6) on the page 300.

C. Candidate Layout Evaluation

Candidate layout evaluation may include one or more of the following steps: determining whether a candidate layout is feasible; computing dimensions for the graphic objects; and computing a layout score. The layout evaluation module 266 has at its disposal a number of distinct evaluation methods. Which method is selected can depend upon the desired layout style and the requirements of the module issuing the request for the layout to be evaluated. Other factors, such as method runtime, computational resources and memory constraints can also influence the choice of layout evaluation method.

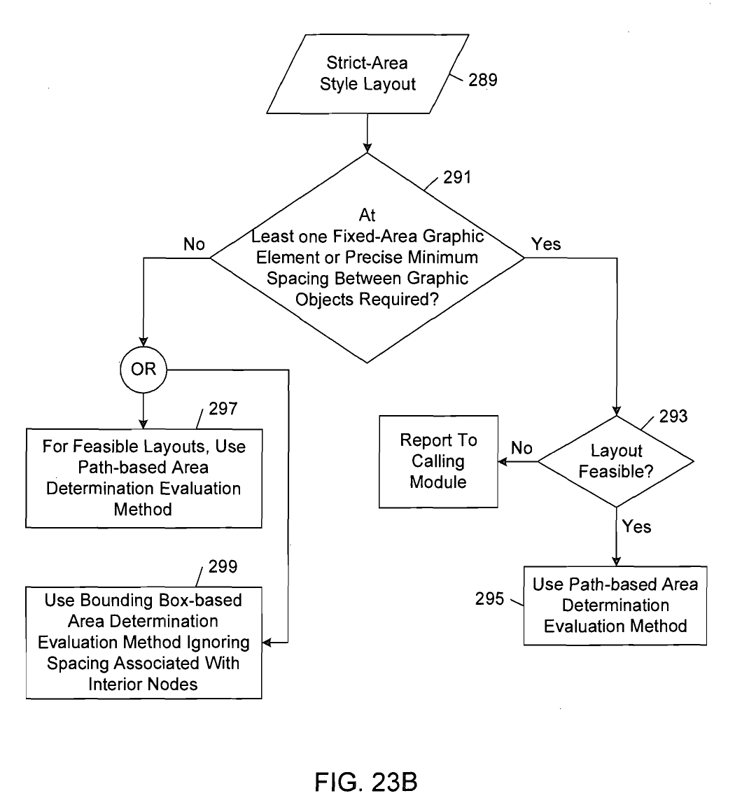

The processes for selecting a layout evaluation method are shown in FIGS. 23A and 23B.

Referring to FIG. 23A, if brick layout style is desired (block 271), then a determination is made whether there is at least one fixed-area graphic object in the set of graphic objects to be laid out on the page (block 273). In the illustrated embodiment, a brick style layout is considered feasible only if all the graphic objects are of variable area. Therefore, if there is at least one fixed-area graphic object in the layout (block 273), the execution of the layout evaluation process terminates (block 275).

Assuming all graphic objects are of type variable-area, a second determination is made as to whether the calling module requires computation of graphic object areas subject to explicit constraints on spacing between adjacent graphic objects (block 277). If the response is in the affirmative, a check is first made as to whether the candidate tree represents a feasible layout as described in detail below (block 279). If the layout is infeasible (block 279), then the calling module is so informed and the candidate layout is discarded (block 281). If the layout is feasible (block 279), the calling module is so informed (if necessary) and the linear-system-based area determination evaluation method described in detail below is used to evaluate the layout (block 283).

If the calling module does not require adherence to constraints associated with spacing between graphic objects (block 277), then one of two procedures is executed by the layout evaluation module 266. In the first procedure, the layout evaluation module 266 verifies that the candidate layout is feasible and employs a is linear-system-based area determination evaluation process (block 285). In the second procedure, the layout evaluation module 66 employs a bounding-box-based area determination evaluation process without testing layout feasibility (block 287). In a typical implementation, the second procedure (block 287) is faster than the first (block 285). In some embodiments, the following rule is used to select which one of the first and second procedures to use for evaluating a layout: if the calling module is the initial layout generator module 64 then the second procedure (block 287) is used; and if the calling module is the final layout generator module 270, the first procedure (block 285) is used.

Referring to FIG. 23B, if strict area layout style is desired (block 289), then a determination is made as to whether the following is true: either there is at least one fixed-area graphic object in the candidate layout, or the calling module requires computation of graphic object areas subject to explicit constraints on spacing between adjacent graphic objects (block 291).

If there is at least one fixed-area graphic object in the candidate layout or the calling module requires computation of graphic object areas subject to explicit constraints on spacing between adjacent graphic objects (block 291), then a check is first made as to whether the candidate tree represents a feasible layout as described in detail below (block 293). If the layout is infeasible, then the calling module is so informed. If the layout is feasible, the calling module is so informed (if necessary) and the path-based area determination evaluation process described in detail below is used to evaluate the layout (block 295).

If there are no fixed-area objects in the candidate layout and the calling module does not require computation of graphic object areas subject to explicit constraints on spacing between adjacent graphic objects (block 291), then one of two available procedures can be followed. In the first procedure, the layout evaluation module 66 verifies that the candidate layout is feasible and employs a path-based area determination evaluation process (block 297) In the second procedure, the layout evaluation module 66 employs a bounding-box-based area determination evaluation process without testing layout feasibility (block 299). In a typical implementation, the second procedure (block 299) is faster than the first (block 297). In some embodiments, the following rule is used to select which of the first and second procedures to use for evaluating a layout: if the calling module is the initial layout generator module 264 then the second procedure (block 299) is used; and if the calling module is the final layout generator module 270, the first procedure (block 297) is used.

1. Feasibility of Candidate Tree Structures

a. Overview

In some embodiments, the layout evaluation module 66 first determines whether a current candidate tree structure represents a feasible candidate relative layout.

A candidate relative layout is feasible if the constituent graphic objects fit within the space available on the page, including consideration of fixed-area graphic objects and any user-specified and system-specified fixed spacing between graphic objects. In the embodiments described above, if there are no fixed-area graphic objects on the page and there is no constraint on spacing between adjacent graphic objects, then any layout is feasible. Thus, as can be deduced from FIGS. 23A and 23B, layout feasibility is only considered if the selected area determination module is either the path-based area determination module or the linear-system-based area determination module. Layout feasibility is not considered if the selected area determination module is the bounding-box-based area determination.

b. Determining Feasibility of Candidate Tree Structures

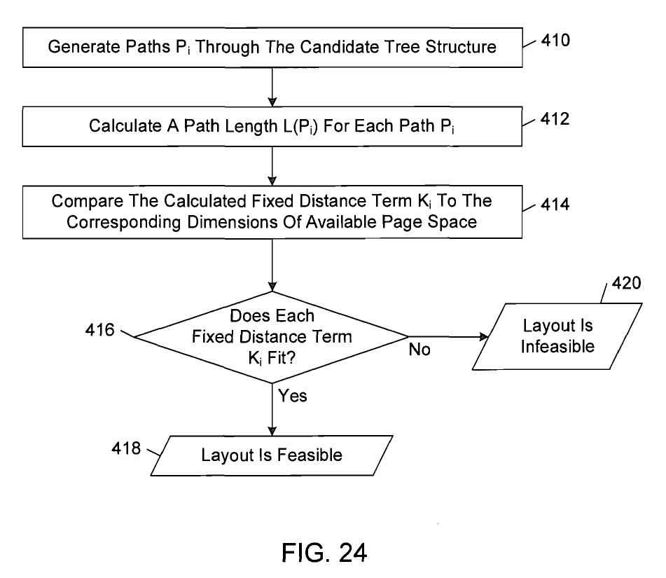

FIG. 24 shows an embodiment by which the layout evaluation module 66 determines the feasibility of a candidate tree structure.

The layout evaluation module 66 generates paths Pᵢ through the candidate structure in accordance with the path generation process described below in connection with FIGS. 9-10J (FIG. 24, block 410).

The layout evaluation module 66 calculates a path length L(Pᵢ) for each path Pᵢ (FIG. 24, block 412). If path Pᵢ is vertical, then its length is

L(Pᵢ)=sum(fixed distances through divisions along Pᵢ)+sum(heights of fixed-area graphic objects on Pᵢ)+sum(heights of variable-area graphic objects on Pᵢ) (2)

The height (H_{GO}) of a graphic object can be written as follows:

H_{GO}=\sqrt{a·A}=\sqrt{a}·\sqrt{A}=Q·\sqrt{a} (3)

where A is the area of the graphic object, a is the aspect ratio defined as the ratio of the height divided by the width, and Q is the square root of the area. Therefore, if Pᵢ is a vertical path, its length can be written

$$L ( {P}_{i} ) = {K}_{i} + {\sum }_{j ∈ {G}_{i}} {Q}_{i , j} \cdot \sqrt{{a}_{i , j}} \qquad ( 4 )$$

where Kᵢ is the sum of the first two terms in equation (2) (i.e., all the fixed distances along path Pᵢ); Q_{i,j} is the square root of the area of the j-th variable area object on path Pᵢ; and a_{i,j} is the aspect ratio of the j-th variable area object on path Pᵢ. Note that the summation term corresponds to the sum of the heights of variable area graphic objects on path Pᵢ.

From a similar derivation, the length of horizontal path Pᵢ can be written

$$L ( {P}_{i} ) = {K}_{i} + {\sum }_{j ∈ {G}_{i}} \frac{{Q}_{i , j}}{\sqrt{{a}_{i , j}}} \qquad ( 5 )$$

where Kᵢ is a sum of horizontal fixed distances and widths of fixed-area graphic objects along path Pᵢ.

The layout evaluation module 266 compares the fixed-distance terms of the paths Kᵢ to the corresponding dimensions of the available page space (FIG. 24, block 414).

If each fixed-distance term fits within the available page space (i.e., Kᵢ≦corresponding page space dimension for each path Pᵢ) (FIG. 24, block 416), the layout evaluation module 266 designates the layout as feasible (FIG. 24, block 418). Otherwise, the layout evaluation module 266 designates the layout as infeasible (FIG. 24, block 420).

c. Generating Paths

i. Overview of Path Generation Method

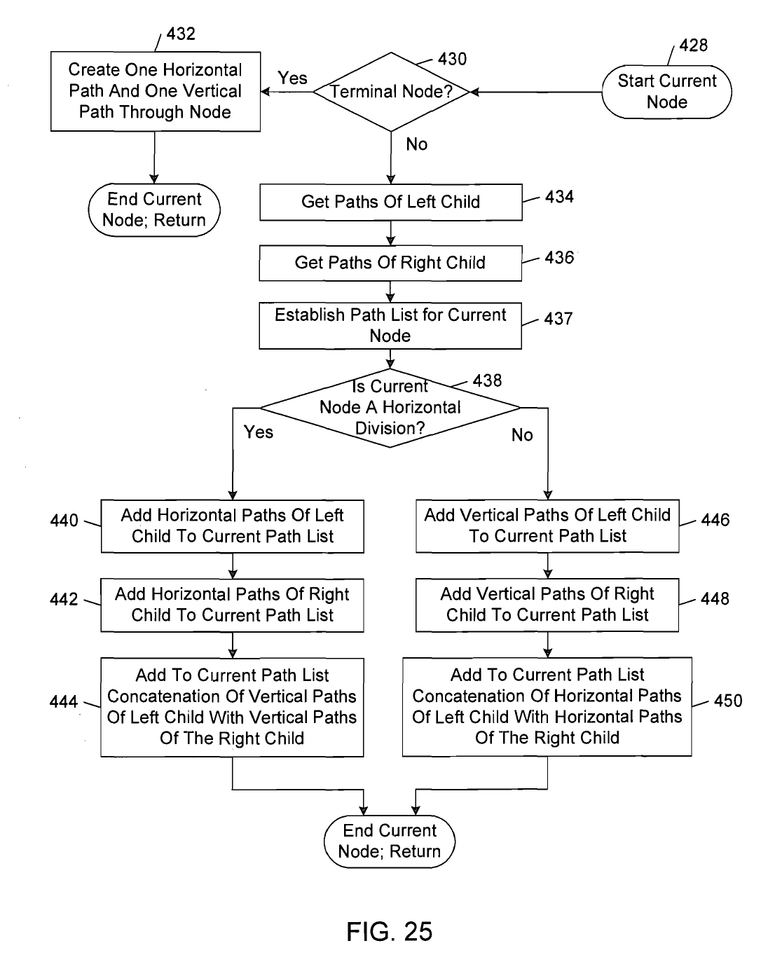

FIG. 25 shows a flow diagram of an embodiment of a method of generating a set of paths through a relative layout of graphic objects on a page.

Briefly, the path generation method of FIG. 25 is executed once for each node in the tree structure corresponding to the relative layout. That is, each node is in its turn the “current node” with respect to which a respective instance of the path generation method begins at block 428. The output of each instance of the path generation method is a set of paths that correspond to the current node. When a current node is a terminal node (i.e., a leaf node), two new paths are established for the current node in block 432. When a current node is an interior node, the current instance of the method is divided into two stages. In the first stage, respective instances of the method are executed for the left and right child nodes of the current node in blocks 434 and 436. In the second stage, the paths for the left and right child nodes are combined to form the paths of the current node in blocks 438-450. When a node is the root node, the paths that result from the corresponding instance of the path generation method are a complete set of paths for the relative layout being processed.

ii. Detailed Description of Path Generation Method

Initially, the path generation method begins at block 428 with the root node of a given candidate relative layout. The path generation method recursively determines the paths for each of the interior and terminal nodes to obtain a complete set of paths through the current candidate relative layout. In the recursive process, the current node is input into the process and a decision is made at block 430 whether or not the current node is a terminal node.

If the current node is a terminal node, two new paths are started at block 432: a horizontal path with a single step traveling through the graphic object associated with the terminal node (e.g., from left to right), and a vertical path with a single step traveling through the graphic object (e.g., from top to bottom). After block 432, the instance of the path generation method that is associated with the current terminal node is complete.

If the current node is not a terminal node (block 430), blocks 434 and 436 submit the two child nodes of the current internal node (i.e., the left child node and the right child node) as current nodes that are processed beginning at node 428 in respective instances of the path generation method. The instance of the is method being executed for the current parent node is on hold during the execution of the instances of the method for the child nodes. In the illustrated embodiment, the instance of the path generation method for the right child is executed after the instance of the path generation method for the left child is completed. The results of the instances of the path generation method that are executed for the left and right child nodes are two sets of paths.

In blocks 437-450, the paths that are determined for the two child nodes are combined. Block 437 establishes a path list for the current node. Block 438 determines if the current internal node represents a horizontal division or a vertical division. If the internal node represents a horizontal division, then the node inherits the horizontal paths of its children (blocks 440, 442) and combines the vertical paths of its children (block 444). In particular, if the current internal node represents a horizontal division, then the current internal node inherits each of the N_{LH} horizontal paths of its left child (block 440), and each of the N_{RH} horizontal paths of its right child (block 442). At block 444, the current internal node obtains a new set of vertical paths by concatenating each of the N_{LV} vertical paths of the left-hand child in its turn with each of the N_{RV} vertical paths of the right-hand child to form (N_{LV}*N_{RV}) vertical paths of the current node. The total number of paths is equal to N_{LH}+N_{RH}+(N_{LV}×N_{RV}).

If the internal node represents a vertical division, then the node inherits the vertical paths of its children (blocks 446, 448), and combines the horizontal paths of its children (block 450). In particular, if the internal node represents a vertical division, then the node inherits each of the N_{LV} vertical paths of its left child (block 446), and each of the N_{RV} vertical paths of its right child (block 448). At block 450, the node obtains a new set of horizontal paths by concatenating each of the N_{LH} horizontal paths of the left-hand child in its turn with each of the N_{RH} horizontal paths of the right-hand child, to form (N_{LH}×N_{RH}) horizontal paths of the current node. The number of paths is thus equal to N_{LV}+N_{RV}+(N_{LH}×N_{RH}).

When a given instance of the path generation method that is being executed for a node is completed (e.g., after blocks 432, 444, and 450), process control returns to the instance that invoked the given instance. When the instance initiated for the root node is completed, the set of paths associated with the root node is the complete set of paths for the relative layout and the path generation method terminates.

iii. Application of the Path Generation Method to an Exemplary Candidate Relative Layout

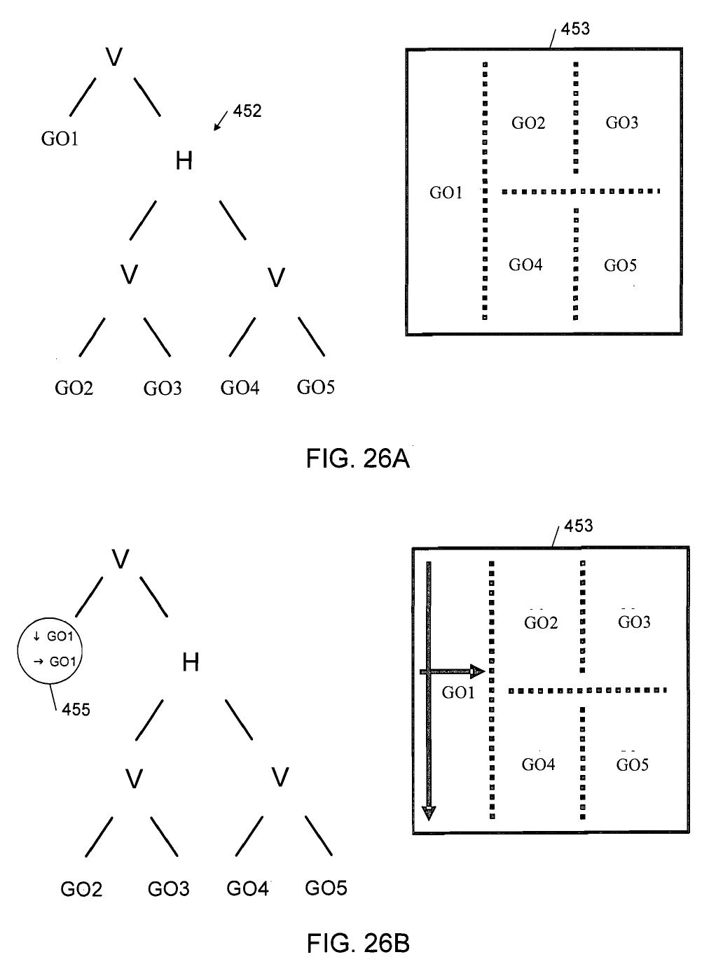

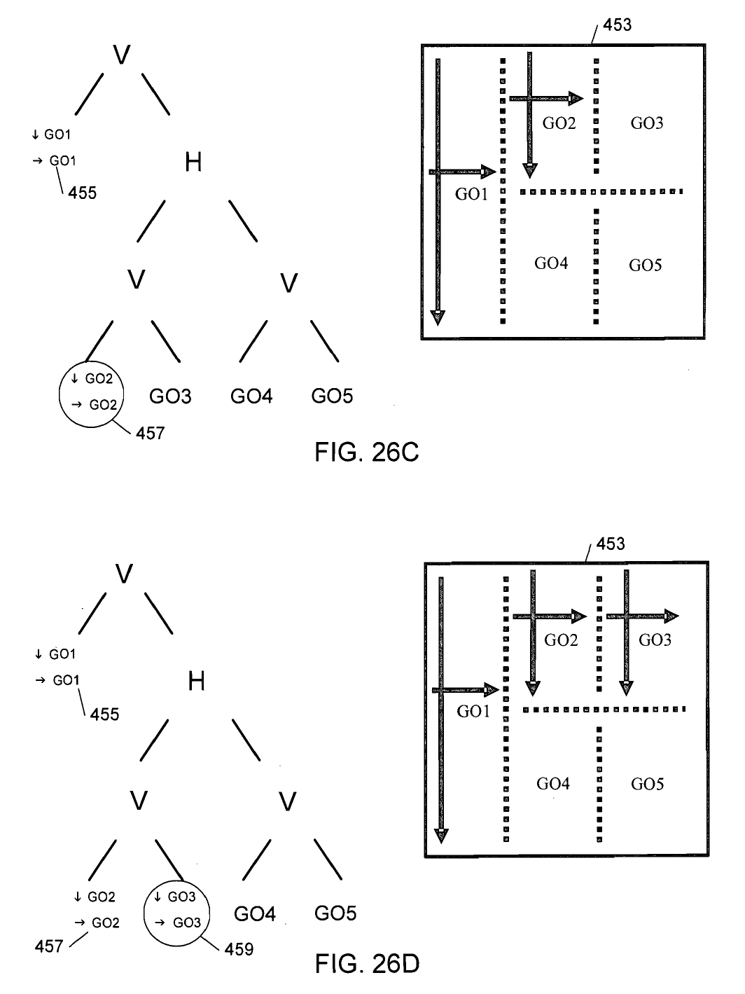

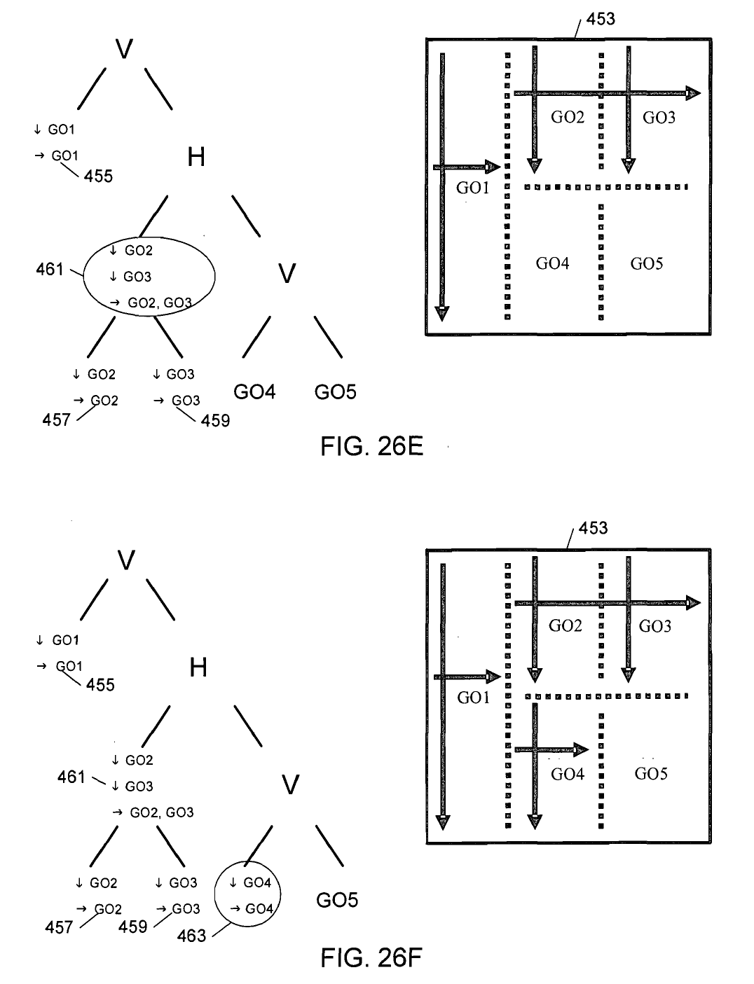

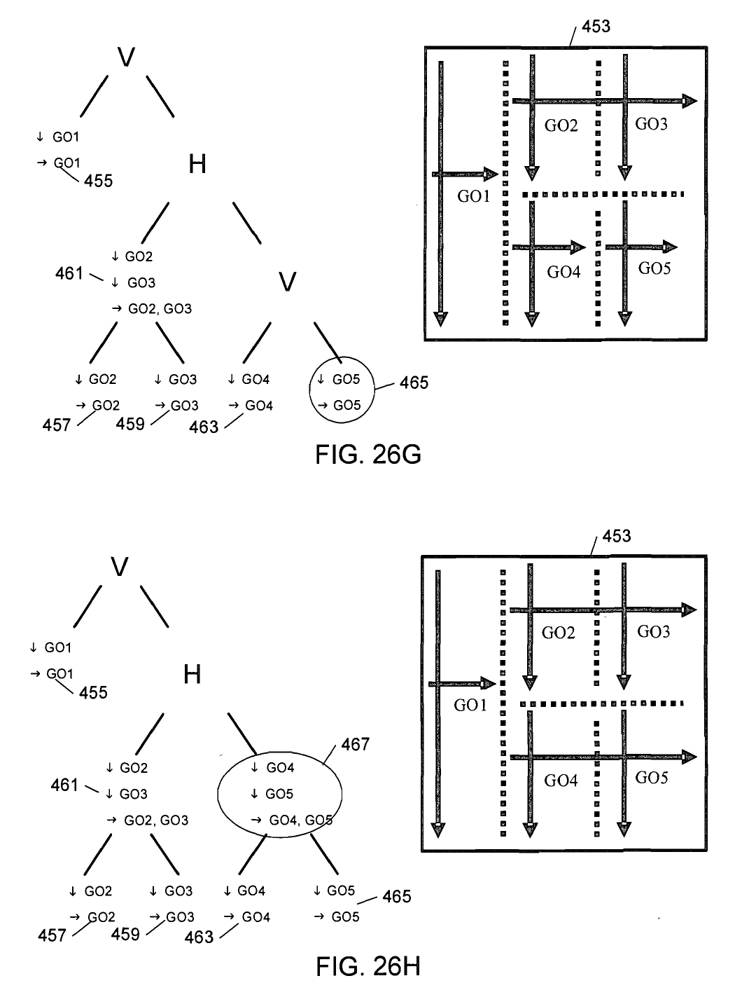

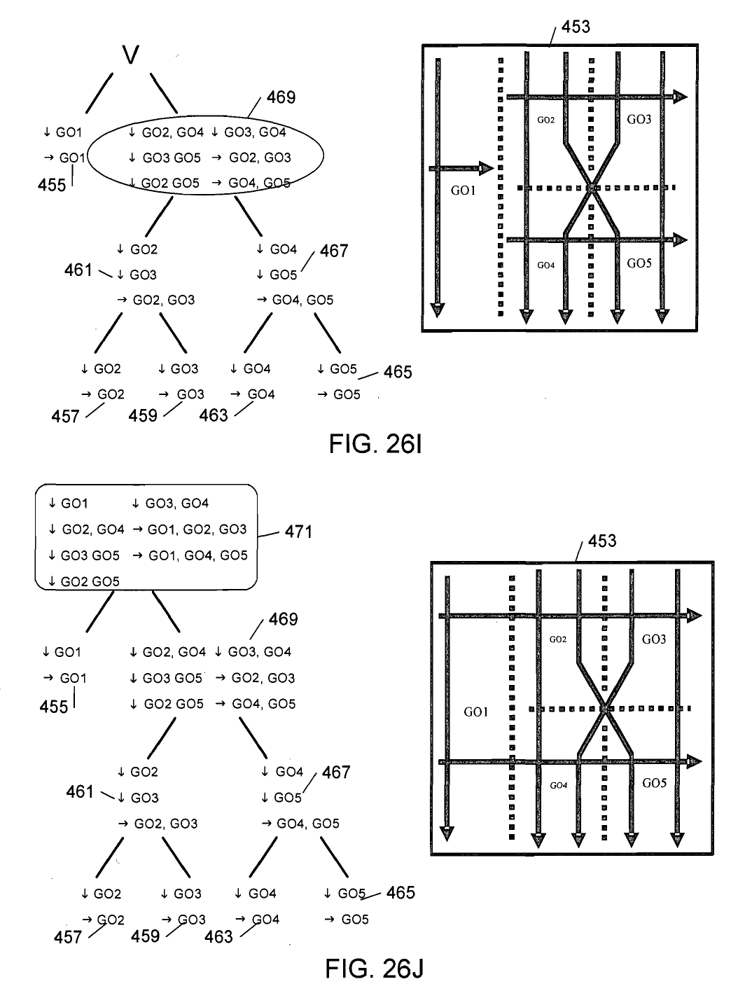

FIGS. 26A-26J show the paths that are generated by the path generation method of FIG. 25 for the respective nodes of a tree structure 452 corresponding to an exemplary candidate relative layout 453.

FIG. 26A shows the tree structure 452 and the corresponding candidate relative layout 453 before the path generation process begins. The horizontal and vertical divisions in the candidate relative layout 452 are shown as dashed lines.

Each of the FIGS. 26B-26J, shows a respective version of the tree structure 452 in which the paths that have been generated up to the completion of an instance of the path generation method for a respective current node, which is circled in the drawings, are shown at the corresponding node locations. The corresponding paths are shown as arrows that are superimposed over the relative layout 453. In the tree structures, each of the paths is denoted by an arrow preceding a respective list of graphic objects. An arrow pointing right preceding a list of graphic objects indicates a horizontal path through the graphic objects. An arrow pointing down preceding a list of graphic objects indicates a vertical path through the graphic objects. For example, “→GO4” indicates a horizontal path through the graphic object GO4; and “→GO4, GO5” indicates a horizontal path through graphic objects GO4 and GO5.

FIG. 26B shows the horizontal and vertical paths that are created in block 432 of FIG. 25 through the terminal node 455 corresponding to graphic object GO1.

FIG. 26C shows the horizontal and vertical paths that are created in block 432 of FIG. 25 through the terminal node 457 corresponding to graphic object GO2. FIG. 26D shows the horizontal and vertical paths that are created in block 432 of FIG. 25 through the terminal node 459 corresponding to graphic object GO3. FIG. 26E shows at the vertical parent node 461 the combination of the paths through GO2 and GO3 that is generated in blocks 440-444 of FIG. 25 for the vertical parent node 461.

FIG. 26F shows the horizontal and vertical paths that are created in block 432 of FIG. 25 through the terminal node 463 corresponding to graphic object GO4. FIG. 26G shows the horizontal and vertical paths that are created in block 432 of FIG. 25 through the terminal node 465 corresponding to graphic object GO5. FIG. 26H shows at the vertical parent node 467 the combination of the paths through GO2 and GO3 that is generated in blocks 440-444 of FIG. 25 for the vertical parent node 467.

FIG. 26I shows at the horizontal parent node 469 the combination of the paths through the vertical nodes 461, 467 that is generated in blocks 446-450 of FIG. 25 for the horizontal parent node 469.

FIG. 26J shows at the vertical root node 471 the complete set of paths through the candidate relative layout 453 corresponding combination of the paths through the terminal node 455 and the vertical node 469 that is generated in blocks 446-450 of FIG. 25 for the root node 471.

2. Evaluating Candidate Tree Structures

In the embodiments that are described in this section of the application, the score that is used to evaluate a candidate relative layout depends on measures of area occupied by the graphic objects on the page.

a. Determining Areas of Graphic Objects

The layout evaluation module 266 calculates the areas occupied by the graphic objects that are specified in a given instance of a candidate relative layout in accordance with a bounding-box-based determination process, a path-based determination process or a linear-system based determination process.

i. Bounding-Box-Based Determination of Graphic Object Areas

In the illustrated embodiments, the objective of the bounding box determination process is to compute an aspect ratio value and nominal size value for each interior node in a given tree structure. Each bounding box is determined by the boxes it encloses.

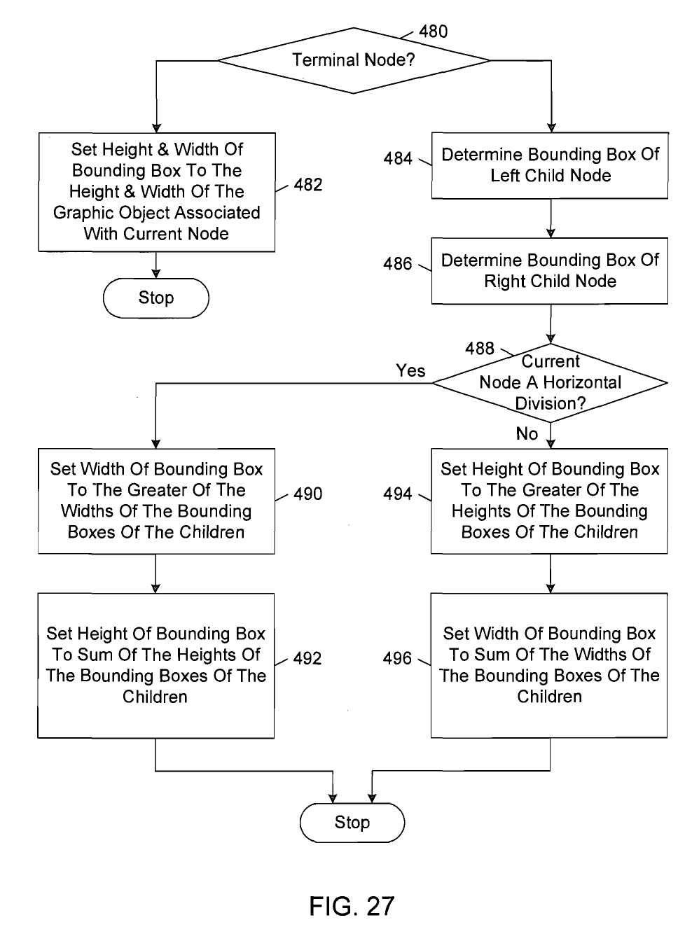

As will be described in greater detail below, the bounding boxes are computed using the nominal sizes of the graphic objects. As described above, these nominal sizes are assumed to be recorded in the page register of the current page. In some implementations, the bounding box characterization process begins at the leaf nodes and works toward the root node, in the order of a depth-first search, as illustrated in FIG. 27.

The formulas for the aspect ratio and nominal size of any interior node are given below. In general, for any image bounding box with an aspect ratio a, and a nominal size, e, the quantities \sqrt{ae} and \sqrt{e/a} are the nominal height and nominal width of the image bounding box, respectively. The aspect ratio, a, and the nominal size, e, for any interior node are functions of the aspect ratios and nominal sizes of its two children. In the following equations, aᵣ and eᵣ are the aspect ratio and nominal size of the right-hand child node, and aₗ and eₗ are the aspect ratio and nominal size of the left-hand child node. Thus, if the right-hand and left-hand child nodes are arranged side-by-side, the aspect ratio and nominal size of the bounding box that encloses them are:

$$\begin{matrix}a = \frac{\sqrt{{a}^{′} {e}^{′}}}{\sqrt{{e}_{1} / {a}_{1}} + \sqrt{{e}_{r} / {a}_{r}}} & ( 6 ) \\ e = \sqrt{{a}^{′} {e}^{′}} ( \sqrt{{e}_{1} / {a}_{1}} + \sqrt{{e}_{r} / {a}_{r}} ) \\ where & ( 7 ) \\ \sqrt{{a}^{′} {e}^{′}} = {max}_{i ∈ \{ r , 1 \}} ( \sqrt{{a}_{i} {e}_{i}} ) & ( 8 )\end{matrix}$$

The aspect ratio in equation (6) is the ratio of the greater nominal height divided by the sum of the two nominal widths, and the nominal size in equation (7) is the product of the greater nominal height and the sum of the two nominal widths. Finding the maximum in equation (8) determines which of the two child node boxes is nominally taller, and therefore governs the height of the parent node box.

If the two child nodes represent boxes that are arranged one on top of the other, the aspect ratio and nominal size of the bounding box that encloses them are:

$$\begin{matrix}a = \frac{\sqrt{{a}_{1} {e}_{1}} + \sqrt{{a}_{r} {e}_{r}}}{\sqrt{{e}^{′} / {a}^{′}}} & ( 9 ) \\ e = ( \sqrt{{a}_{1} {e}_{1}} + \sqrt{{a}_{r} {e}_{r}} ) \sqrt{{e}^{′} / {a}^{′}} \\ where & ( 10 ) \\ \sqrt{{e}^{′} / {a}^{′}} = {max}_{i ∈ \{ r , 1 \}} ( \sqrt{{e}_{i} / {a}_{i}} ) & ( 11 )\end{matrix}$$

In this case, equation (11) determines which of the two child node boxes is is nominally wider, and therefore governs the width of the parent node box.

The bounding box of the root node conveys the shape and nominal size of the entire layout of the page specified by the corresponding tree structure. The bounding box of the root node is referred to herein as the “principal bounding box”.

When the aspect ratio and nominal size of the principal bounding box are known, the bounding-box based area Aᵢ for graphic object i is computed as

$${A}_{i} = \frac{{e}_{i}}{{e}_{pbb}} {A}_{pbb} \qquad ( 12 )$$

where eᵢ and e_{pbb} are the nominal sizes of graphic object i and the principal bounding box respectively, and where A_{pbb} is an area for the principal bounding box, computed as

$${A}_{pbb} = {A}_{page} \frac{min \{ {a}_{pbb} , {a}_{page} \}}{max \{ {a}_{pbb} , {a}_{page} \}} \qquad ( 13 )$$

where A_{page} is the area of the usable page space.

FIG. 27 shows a flow diagram of an embodiment of a recursive process by which the layout evaluation module 266 calculates relative height and width dimensions of the bounding boxes for the nodes of a tree structure.

The process begins with the root node as the current node. A decision is made whether the current node is a terminal node (FIG. 27, block 480). If the current node is a terminal node, a bounding box is established that has the nominal height and width of the associated graphic object (FIG. 27, block 482). If the current node is not a terminal node, the two child nodes of the current node (i.e., the left child node and the right child node) are submitted to the same recursive process (FIG. 27, blocks 484, 486). The bounding boxes of the two children are combined to form the bounding box for the current node as follows. The layout evaluation module 266 determines if the current node is a horizontal division or a vertical division (FIG. 27, block 488). If current node represents a horizontal division, then the nominal width of the bounding box is set to the nominal width of the wider of the bounding boxes of the two children (FIG. 27, block 490) and the nominal height of the bounding box is set to the sum of the nominal heights of the bounding boxes of the two children. If the current node represents a vertical division (FIG. 27, block 488), the nominal height of the bounding box is set to the nominal height of the taller of the bounding boxes of the two children (FIG. 27, block 494) and the nominal width of the bounding box is set to the sum of the nominal widths of the bounding boxes of the two children. This process continues until the bounding box for the root node has been computed.

ii. Path-Based Determination of Graphic Object Areas

In strict area style layout, each variable-area graphic assembly has an assigned nominal size, which is denoted by the variable e. In the context of a multi-element graphic object, which has more than one constituent single-element graphic object (such as a series of keyframes from a video), a single aggregate nominal size is assigned to the entire graphic object and the nominal sizes of the individual graphic objects in the multi-element graphic object are set to equal the aggregate nominal size divided by the number of graphic objects in the graphic object. In the remainder of this section it is assumed that each graphic object j on a path Pᵢ is a single-element graphic object that has a positive nominal size eⱼ. Since a nominal size is proportional to the actual area, the variable Q, which is defined above, can be generalized to reflect the square root of a nominal size (rather than an absolute area) as follows:

Q=g·\sqrt{e} (14)

where g is a positive scalar such that g² multiplied by the nominal size is an absolute measurable area (e.g., square inches). The ratio of Q divided by \sqrt{e} is a constant across all variable-area graphic objects, so that the same value of g is used for all variable-area graphic objects on the page. Thus, in equations (4) and (5) above, when substituting g·\sqrt{e} for Q, g can be pulled out of the summation terms to arrive at:

$$\begin{matrix}L ( {P}_{i} ) = {K}_{i} + g \cdot {\sum }_{j ∈ {G}_{i}} \sqrt{{e}_{i , j}} \cdot \sqrt{{a}_{i , j}} & ( 15 ) \\ L ( {P}_{i} ) = {K}_{i} + g \cdot {\sum }_{j ∈ {G}_{i}} \frac{\sqrt{{e}_{i , j}}}{\sqrt{{a}_{i , j}}} & ( 16 )\end{matrix}$$

where e_{i,j} is the nominal size of the j^{th} variable-area graphic object on path Pᵢ.

If path Pᵢ is a vertical path and the available area on the page has height H_{PAGE}, then solving the following equation for gᵢ yields the value for which Pᵢ is exactly as long as the available area is high:

$${H}_{PAGE} = {K}_{i} + {g}_{i} \cdot {\sum }_{j ∈ {G}_{i}} \sqrt{{e}_{i , j}} \cdot \sqrt{{a}_{i , j}} \qquad ( 17 )$$

Similarly, if path Pᵢ is a horizontal path and the available area has width W_{PAGE}, then solving the following equation for gᵢ yields the value for which the path fits exactly across the width of the available area:

$${W}_{PAGE} = {K}_{i} + {g}_{i} \cdot {\sum }_{j ∈ {G}_{i}} \frac{\sqrt{{e}_{i , j}}}{\sqrt{{a}_{i , j}}} \qquad ( 18 )$$

In one embodiment, areas for variable-area graphic objects are made as large as possible, while still allowing all the graphic objects to fall completely on the usable area of the page, by (for each path Pᵢ) solving for gᵢ using either equation (17) or (18), depending on whether Pᵢ is a vertical or horizontal path. Because the layout has previously been determined to be feasible, as described above, each solution for gᵢ will be positive. If g* is defined to be the smallest solution across all the paths:

g*=minᵢ{gᵢ} (19)

then the area Aⱼ of the j^{th} variable-area graphic object is computed as

Aⱼ=(g*)²·eⱼ (20)

where eⱼ is the nominal size assigned to the j^{th} variable-area graphic object.

iii. Linear-System-Based Determination of Graphic Object Areas

In brick style layouts, graphic element areas are determined by first computing values of Q. Once the values of Q are known, they can be squared to compute absolute, measurable areas (e.g., square inches). Values of Q are computed for two hypothetical scenarios: (I) the height of the area occupied by graphic elements is constrained to equal the height of the usable area on the page; and (II) the width of the area occupied by graphic elements is constrained to equal the width of the usable area on the page. In most cases, only one of scenarios (I) and (II) will yield a feasible solution because in the other scenario, the unconstrained dimension will be greater than the available space. The scenario yielding the feasible solution is selected to produce the final set of graphic element areas.

In either scenario (I) or (II), values of Q are computed as the solution to a linear system of equations having N unknowns, where N is the number of graphic elements. Each of N−1 of the equations comes from an interior node of the complete tree structure, because in a tree accommodating N graphic elements, there are exactly (N−1) interior nodes.

For an interior node that represents a vertical division or cut of the area, the corresponding equation is derived by first obtaining two vertical paths, one path from each of its two children, and setting their lengths to be equal. Referring to equation (15) above, denoting the vertical path from the left-hand child as P_{L} and from the right-hand child as P_{R}, the corresponding expression is given by:

$${K}_{R} + {\sum }_{j ∈ {G}_{R}} {Q}_{R , j} \cdot \sqrt{{a}_{R , j}} = {K}_{L} + {\sum }_{k ∈ {G}_{L}} {Q}_{L , k} \cdot \sqrt{{a}_{L , k}} \qquad ( 21 )$$

where the variable j indexes the graphic objects along P_{R} and k indexes the graphic objects along P_{L}. Rearranging equation (21) yields

$${\sum }_{j ∈ {G}_{R}} {Q}_{R , j} \cdot \sqrt{{a}_{R , j}} - {\sum }_{k ∈ {G}_{L}} {Q}_{L , k} \cdot \sqrt{{a}_{L , k}} = {K}_{L} - {K}_{R} \qquad ( 22 )$$

The situation is analogous for an interior node that represents a horizontal division or cut of the area. Two horizontal paths are obtained, and their lengths set to be equal, yielding

$${\sum }_{j ∈ {G}_{R}} \frac{{Q}_{R , j}}{\sqrt{{a}_{R , j}}} - {\sum }_{k ∈ {G}_{L}} \frac{{Q}_{L , k}}{\sqrt{{a}_{L , k}}} = {K}_{L} - {K}_{R} \qquad ( 23 )$$

By constructing an equation of the form of either (22) or (23) for each interior node, N−1 equations are obtained for N unknowns.

For scenario I, the N^{th} equation is obtained by setting the length of any vertical path from the root node equal the height of the available area. For scenario II, the N^{th} equation is obtained by setting the length of any horizontal path from the root node equal the width of the available area.

For both scenarios I and II, the N equations are written in matrix-vector form (Ax=b). The matrix contains only zeros, positive and negative square roots of graphic element aspect ratios, and positive and negative inverses of square roots of graphic element aspect ratios. The N elements of vector x are the Q variables. Among the N elements of vector b, (N−1) are computed as the right-hand side of either equation (21) or equation (22), and the other is equal to the height (scenario I) or width (scenario II) of the available area (minus the fixed distance along the path used to obtain the corresponding row). Computing inverse(A)*b yields the vector of Q values.

b. Scoring Tree Structures

In some embodiments, the initial layout generator module 64 selects candidate layouts by identifying those having the highest fitness or score. These scores are computed by the layout evaluation module 266 using a scoring, evaluation, or fitness function of the type described above in section III.B.2. The scoring, evaluation, or fitness function promotes the production of final layouts in which the sizes of the graphic objects are closer to the nominal sizes assigned to the graphic objects. In some embodiments, the layout evaluation module 266 calculates for each of the candidate layouts a respective layout score based on degrees to which actual rendering sizes of the graphic objects in the candidate layout match the respective target rendering sizes. The scoring function typically incorporates a metric that provides an indication of how close the actual sizes of the graphic objects in a given layout are to their assigned nominal sizes. In some of these embodiments, the layout evaluation module 266 calculates a respective graphic object score for each of the graphic objects in each of the candidate layouts based on a ratio of the actual rendering size to the respective target rendering size. The layout evaluation module 266 calculates for each of the candidate layouts a respective layout score from the respective graphic object scores.

In some embodiments, the scoring, evaluation, or fitness function that is used by the layout evaluation module 266 corresponds to the target layout score function that is defined by the pseudo code described above in section III.B.2.

In some embodiments, the scoring, evaluation, or fitness function that is used by the layout evaluation module 266 combines the target layout score function that is defined by the pseudo code described above in section III.B.2 with one or more other metrics. Other metrics that may or may not be included in the fitness or scoring function include, but are not limited to, coverage (i.e., the fraction of the page occupied by graphic objects) and consistency (i.e., the variation in the areas occupied by graphic objects on the page).

For example, in embodiments where strict area layout style is desired, the layout evaluation module 266 computes a layout score that combines the target layout score function that is defined by the pseudo code described above in section III.B.2 with coverage. In some embodiments, coverage is computed as the sum of the graphic object areas on the page. These areas may have been computed either by the path-based area determination method or by the bounding-box based area determination method.

In embodiments where brick layout style is desired, the layout score combines the target layout score function that is defined by the pseudo code described above in section III.B.2 with both coverage and consistency. In some of these embodiments, the combined layout score (Score) is calculated in accordance with equation (24):

Score=a₁layout_score+a₂α+a₃υ (24)

The parameters a₁, a₂, and a₃ are empirically determined weighting factors. The variable α measures how well the aspect ratio of the usable area on the page agrees with the aspect ratio of the principal bounding box. The variable υ measures consistency. In some embodiments, each of the variables α and υ has a value in the range of 0 and 1, where 0 corresponds to low coverage and consistency and 1 corresponds to high coverage and consistency. In these embodiments, the variable α is computed as follows:

$$α = \frac{min ( page\_aspect , pbb\_aspect )}{max ( page\_aspect , pbb\_aspect )} \qquad ( 25 )$$

where page_aspect is the aspect ratio of the usable area on the page, and pbb_aspect is the aspect ratio of the principal bounding box (i.e., the bounding box associated with the root node). The variable υ is computed as follows:

$$v = \frac{min ( area of graphic objects on page )}{max ( area of graphic objects on page )} \qquad ( 26 )$$

In equation (26), the graphic object areas may be computed by either the linear-system based area determination method or the bounding-box based area determination method. In these embodiments, the consistency measure υ is defined to be the minimum graphic object area divided by the maximum graphic object area.

Other embodiments may use different scoring functions for brick style layouts. For example, the score computed in accordance with equation (24) may be penalized for values of α and/or υ that are below predetermined thresholds. In some implementations, the values of α and/or υ may take into account any space between graphic objects.

### V. Generating an Initial Arrangement of Graphic Objects on a Page

A. Overview of Process of Generating an Initial Arrangement of Graphic Objects

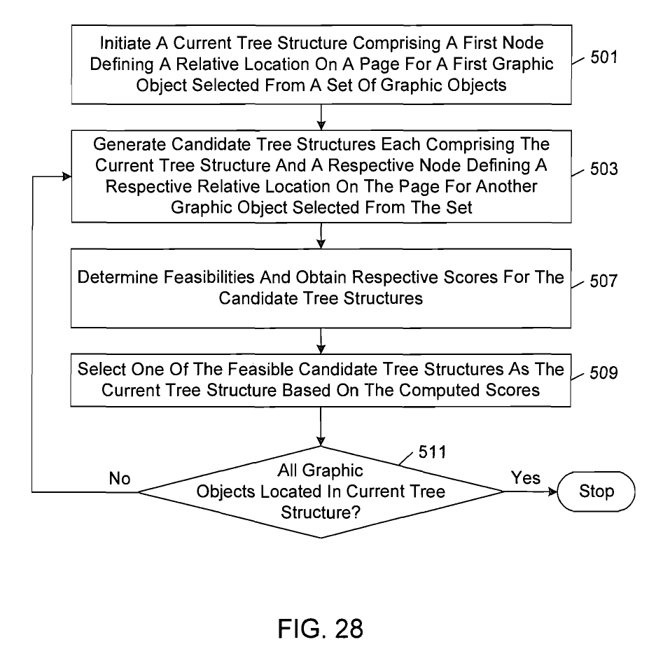

FIG. 28 shows a flow diagram of an embodiment of a method by which the initial layout generator module 264 generates a binary tree structure defining an initial arrangement 280 of graphic objects 270 on a page.

The initial layout generator module 264 initiates a current tree structure that includes a first node, which defines a relative location on a selected one of the pages for a first graphic object selected from a set of graphic objects (FIG. 28, block 501).

The initial layout generator module 264 generates candidate tree structures each comprising the current tree structure and a respective node defining a respective relative location on the selected page for another graphic object selected from the set (FIG. 28, block 503). The initial layout generator module 264 generates each candidate tree structure by adding one graphic object to the current tree structure.

After the multi-element graphic objects in the current tree structure have been expanded (using an expansion process described below), the initial layout generator module 264 obtains respective feasibility test results and scores based at least in part on the corresponding initial size dimensions for the candidate tree structures (FIG. 28, block 507). These scores and feasibility test results are obtained from the layout evaluation module 266. Any candidate tree structure deemed infeasible by the layout evaluation module 266 is eliminated from consideration.

The initial layout generator module 264 selects one of the candidate tree structures as the current tree structure based on the computed scores (FIG. 28, block 509).

The initial layout generator module 264 repeats the processes of generating (FIG. 28, block 503), obtaining (FIG. 28, block 507), and selecting (FIG. 28, block 509) until relative locations on the page are defined for all of the graphic objects in the set by respective nodes in the current tree structure (FIG. 28, block 511).

The process of FIG. 28 is repeated for each of the one or more pages on which the graphic objects are to be laid out.

In the process defined in FIG. 28, the tree structure generation process begins with a single graphic object, and additional graphic objects are added to the tree structure one at a time until all of the graphic objects that are assigned to the page have been added. If the total number of graphic objects assigned to a page is M, the layout for the page corresponds to the last in an increasing sequence of binary trees:

T(1), T(2), . . . , T(M) (27)

where T(p) for p≧1 denotes a tree with p terminal nodes. Each of the intermediate trees {T{p}: 1≦p≦N−1} generates a viable layout.

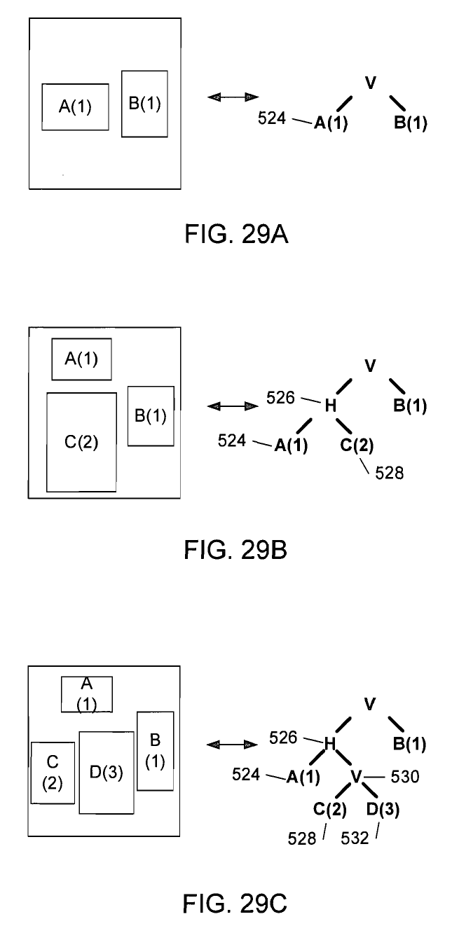

FIGS. 29A-29C show different partitions of a page and corresponding hierarchical tree structures at different stages of the tree structure generation process, where the numbers in parentheses are the nominal sizes assigned to the corresponding graphic objects A, B, C, D. Each node in the tree structure is associated with a bounding box in the layout of a page. Each interior node is associated with a bounding box around the boxes of its two child nodes, and each leaf node is associated with a cell where a respective graphic object is to be placed.

Each new graphic object is added to the tree structure by introducing a new cell to the previous layout. Thus, graphic object C is added to the sub-tree structure 524 shown in FIG. 29A by displacing the sub-tree structure 524 with a new interior H node 526 shown in FIG. 29B. The new interior H node 526 becomes the parent of a new leaf node 528 corresponding to the new cell C(2) and the sub-tree 524 that was displaced. Similarly, the graphic object D is added to the sub-tree structure 528 shown in FIG. 29B by displacing the sub-tree structure 528 with a new internal V node 530 shown in FIG. 29C. The new internal V node 530 becomes the parent of a new leaf node 532 corresponding to the new cell D(3) and the sub-tree 528 that was displaced. In the example illustrated in FIGS. 29A-29C, the selected sub-trees 524 and 528 that are displaced happened to be leaf nodes; in general, however, any sub-trees could have been selected, including sub-trees that are rooted at interior nodes. A sub-tree is defined as a node, designated as the sub-tree root, taken together with all the nodes that emanate from it. If the sub-tree root is an interior node, then the sub-tree includes both interior nodes and the terminal nodes that are its children.

As explained in detail below, the layout generator module 264 selects which cell is introduced into a previous layout by evaluating a collection of candidate relative layouts corresponding to all possible presentations of the new graphic object in each of the available new cell locations. Before each of the candidate relative layouts is evaluated, however, the coarse graphic object tree structures corresponding to the candidate relative layouts of multi-element graphic objects are expanded (or translated) into refined (or complete) tree structures whose leaves correspond to the individual constituent graphic objects of the graphic objects.

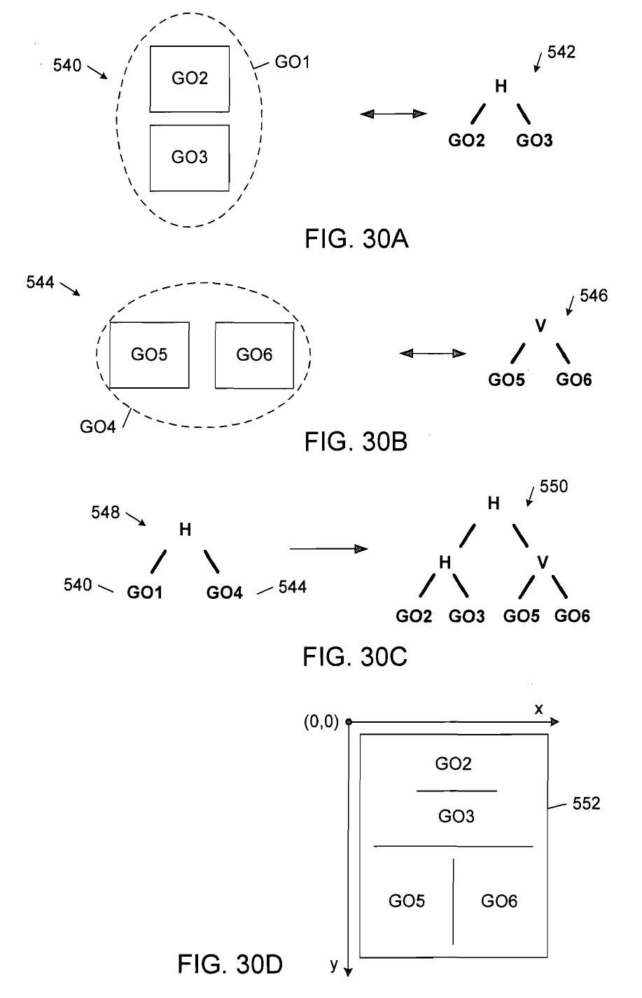

In one exemplary illustration, FIG. 30A shows one presentation of a graphic object 540 (GO1) and its corresponding tree structure 542. FIG. 30B shows one presentation of a graphic object 544 (GO4) and its corresponding tree structure 546. FIG. 30C shows a coarse tree structure 348 that consists of a horizontal root node and two terminal nodes corresponding to the graphic object presentations 540, 544 shown in FIGS. 29A and 29B. The coarse tree structure 548 is expanded into a refined tree structure 350 by substituting the tree structures 542, 546 for the terminal nodes representing the graphic object presentations 540, 544, as shown in FIG. 30C. FIG. 30D shows the resulting candidate relative layout corresponding to the refined tree structure 550 in a page 552.

B. Exemplary Process of Generating and Initial Arrangement of Graphic Objects

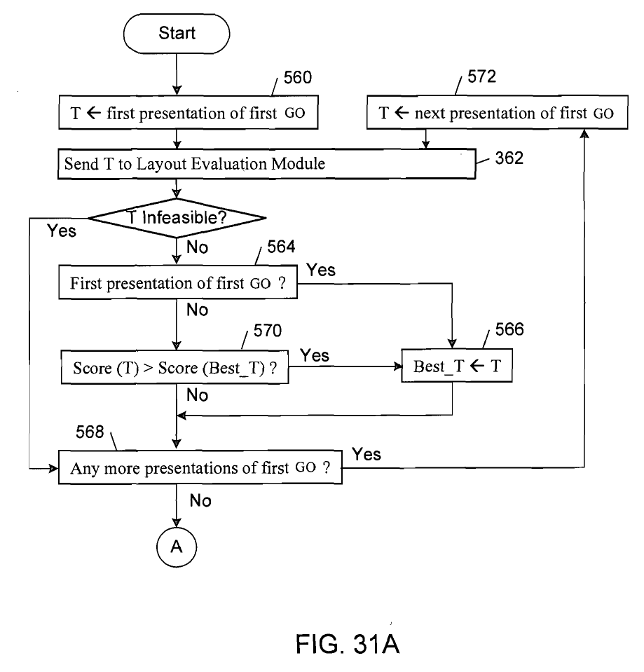

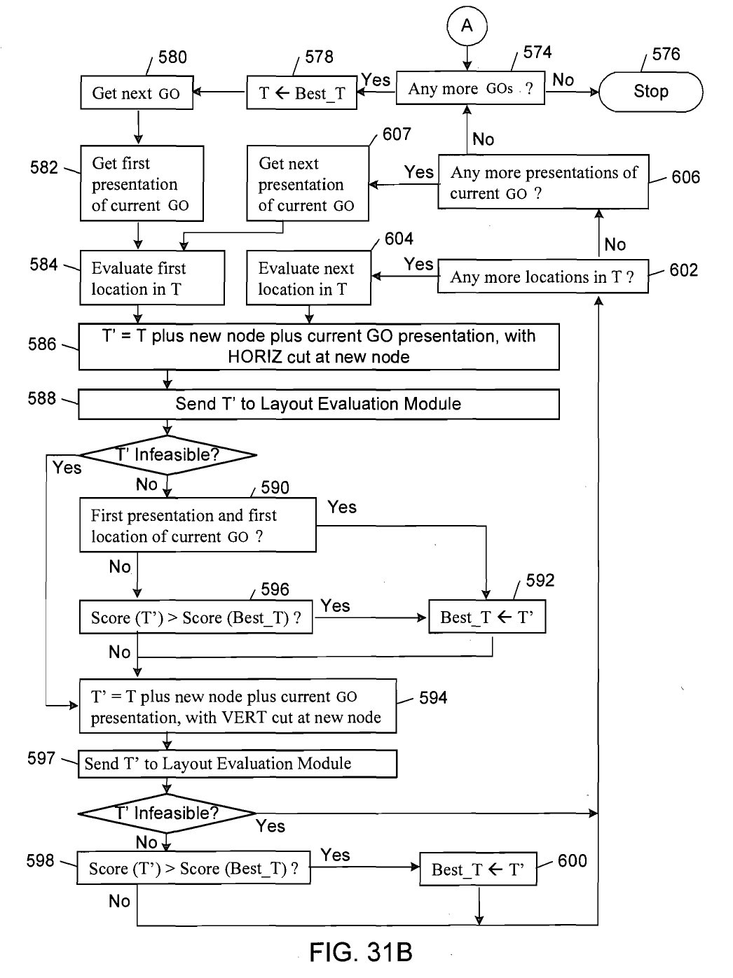

FIGS. 31A and 31B show an embodiment of an exemplary method by which the initial layout generator module 264 generates candidate relative layouts and selects one of the candidate relative layouts as the initial arrangement 80 of graphic objects on a page (see FIG. 20).

Block 560 initiates a current candidate layout T with a first presentation of the first graphic object (GO). Block 362 sends the current candidate layout T to the layout evaluation module 266 (see FIG. 20). As explained in detail above, the layout evaluation module 266 confirms the feasibility of the candidate relative layout, determines initial size dimensions for the graphic objects in the current candidate layout T, and computes a score Score(T) for the current candidate layout T based at least in part on the initial size dimensions.

If the layout evaluation module deems the candidate layout infeasible, the candidate layout is discarded and the process moves directly to block 568.

If the candidate layout is feasible, block 564 determines whether this is the first presentation of the first graphic object. If this is the first presentation of the first graphic object, block 566 designates tree T as the current best layout, Best_T, and proceeds to block 568. If this is not the first presentation of the first graphic object, block 570 compares Score(T) to a score, Score(Best_T), for the layout corresponding to the best tree where scoring may be performed in the manner described above. If Score(T) is greater than Score(Best_T), block 566 designates the current candidate layout T as the new Best_T, and proceeds to block 568. If Score(T) is not greater than Score(Best_T), the best current candidate layout designation is not changed, and the process proceeds to block 568.

Block 568 determines whether any additional presentations of the first graphic object are available. If more presentations of the first graphic object are available, block 572 retrieves the next presentation of the first graphic object to form a new current candidate layout T and the process is repeated for the new current candidate layout. If block 568 determines that there are no additional presentations of the first graphic object, the process proceeds to block 574 in FIG. 31B.

Block 574 determines whether there are any more graphic objects to be added to the current candidate layout. If there are no more graphic objects to be added to the current candidate layout, the current Best_T is selected as the final layout from the initial arrangement generation process and the process terminates at block 576.

If block 574 determines there are additional graphic objects to be added to the current candidate layout, then block 578 designates the current best layout, Best_T, as the new current candidate layout T. Block 580 retrieves the next current graphic object. Block 582 retrieves (or determines) the first presentation of the current graphic object. Block 584 selects a first location in the current candidate layout T at which to evaluate the current graphic object presentation. The location may be either an internal node or an external node (i.e., leaf) of the current candidate layout T. At block 586, an alternative candidate layout T′ is created by adding a new node at the first location. One child of the new node is the subtree of the current candidate layout T whose root is the location in T. The other child of the new node is the current presentation of the current graphic object being added to the layout. In the alternative current candidate layout T′, a horizontal division is assigned to the new node.

Block 588 sends the alternative candidate layout T′ to the layout evaluation module 266. As explained in detail above, the layout evaluation module 266 confirms the feasibility of the candidate relative layout, determines initial size dimensions for the graphic objects in the alternative candidate layout T′, and computes a score Score(T′) for the alternative candidate layout T′ based at least in part on the initial size dimensions.

If the layout evaluation module deems the candidate layout infeasible, the candidate layout is discarded and the process moves directly to block 594.

If the candidate layout is feasible, block 590 determines if this is the first location and first presentation of the current graphic object. If this is the first location and first presentation of the current graphic object, block 592 designates the alternative candidate layout T′ as the best current layout, Best_T, and proceeds to block 594. If this is not the first location and first presentation of the current graphic object, block 596 compares Score(T′) with a score, Score(Best_T), for the layout corresponding to the best current layout where scoring may be performed in the manner described above. If Score(T′) is greater than Score(Best_T), (indicating the alternative candidate layout T′ is better than the current candidate layout T), then block 592 designates T′ as the best current layout, Best_T, and the process proceeds to block 594. If Score(T′) is less than or equal to Score(Best_T), the best current layout designation is not changed and operation proceeds to the same block 594.

At block 594, another alternative current layout T′ is created by adding a new node in the place of the current location. One child of the new node is the subtree of T whose root is the location of T. The other child of the new node is the current presentation of the graphic object currently being added to the layout. In the alternative current layout T′ of block 594, a vertical division is assigned to the new node.

Block 597 sends the alternative candidate layout T′ to the layout evaluation module 266. The layout evaluation module 266 confirms the feasibility of the is candidate relative layout, determines initial size dimensions for the graphic objects in the alternative candidate layout T′, and computes a score Score(T′) for the alternative candidate layout T′ based at least in part on the initial size dimensions.

If the layout evaluation module deems the candidate layout infeasible, the candidate layout is discarded and the process moves directly to block 602.

If the candidate layout is feasible, block 598 determines a score, Score(T′), for the layout corresponding to the alternative candidate current layout T′ and compares Score(T′) with Score(Best_T). Blocks 570, 596, 598 may use the same or different scoring methods. If the Score(T′) is greater than Score(Best_T), block 600 designates alternative current layout T′ as the best current layout, Best_T, and the process proceeds to block 602. If block 598 determines the score of T′ is not greater than the score of Best_T, the process proceeds directly to block 602.

Block 602 determines whether there are any additional locations available in the current candidate layout T. If additional locations are available in current candidate layout T, block 604 selects a new location in the current candidate layout T at which to evaluate the current graphic object presentation. Blocks 586 through 602 are repeated using the same current graphic object presentation.

When block 602 determines that no additional locations are available in the candidate layout T, the process proceeds to block 606. Block 606 determines whether there are any additional presentations of the current graphic object to consider. If additional presentations of the graphic object are available, the process proceeds to block 607, which retrieves the next presentation of the current graphic object. Block 584 selects the first location in the current candidate layout T at which to evaluate the current graphic object presentation. Blocks 586-604 evaluate the next presentation of the current graphic object T in each available location in the current candidate layout T.

When block 606 determines that there are no more presentations of the current graphic object to consider, the process proceeds to block 574, which determines if there are any additional graphic objects to be added to the current candidate layout. When block 574 determines there are no more graphic objects to be added to the current candidate layout, the current Best_T is selected as the final determinate layout and the process terminates at block 576.

### VI. Generating a Final Arrangement of Graphic Objects on a Page

As explained above, final layout generator module 270 receives tree structures representing page partitions from either the initial layout generator module 264 or the layout modification module 68, depending on whether or not the layout modification module 68 is included in the graphic object arrangement system 60. Each leaf node of a tree structure has an aspect ratio value (a) and, if a in the case of strict-area style layout, a nominal size value (e); and each interior node indicates either a horizontal or vertical division on the page. The final layout generator module 270 determines areas of the graphic objects on each page and then allocates a precise region of page space to each node. The allocated regions of the page are nested in the same ay as the corresponding tree structures. The allocated regions are referred to herein as “cells”. In some implementations, once a cell is known, the position of a graphic object assigned to the cell is determined by centering the graphic object in the cell.

A. Determining Graphic Objects Areas

The areas of the graphic objects are determined by either the bounding-box-based area determination method or the path-based area determination method or the linear-system-based area determination method, depending on the desired accuracy, the desired layout style and the available computing resources. In some cases, the final layout generator module 270 may use the graphic object areas calculated by the layout evaluation module 266 for the immediately preceding upstream layout module using one of the graphic object area determination methods described above. In other cases, the final layout generator module 270 may direct the layout evaluation module 266 to compute the graphic object areas using a different one of the graphic object area determination methods described above.

B. Determining Bounding Boxes Around the Nodes in the Tree Structure

After absolute areas are computed, bounding boxes are characterized around each node in the tree structure. The actual steps required to accomplish this process are perfectly analogous to the process for computing bounding boxes described above in connection with bounding-box-based area determination, as show in FIG. 27, with two exceptions. First, the nominal sizes happen to be actual graphic object areas. Second, the spacing assigned to interior nodes is not ignored, but rather added to the sums in the computations of blocks 492 and 496.

C. Allocating Page Space to Graphic Objects

1. Overview of Page Space Allocation Process

In some embodiments, the process of allocating regions of page space to nodes involves dividing a page into cells and positioning each graphic object in its respective cell. The page is divided into cells by splitting the page into rectangles, starting with the entire usable area of the page as the first rectangle. Each split is accomplished by drawing a line segment for a respective one of the interior nodes, starting at the root node in order of a breadth-first search.

In the case of an interior node corresponding to a vertical division, the final layout generator module 270 selects a horizontal position x along the width of the available region. In one formulation, x ε (0,1), where x=0 represents the leftmost position and x=1 represents the rightmost position in the available region. In this case,

$$x = \frac{\sqrt{{e}_{1} / {a}_{1}}}{\sqrt{{e}_{1} / {a}_{1}} + \sqrt{{e}_{r} / {a}_{r}}} \qquad ( 28 )$$

where aₗ, eₗ, and aᵣ, eᵣ are the aspect ratios and areas of the bounding boxes for the left and right children of the interior node. This formulation makes direct use of widths as proportions. The analogous formula for a horizontal division uses the heights. That is, if the vertical position along the height of the available space is denoted y ε (0,1), where y=0 represents the bottom position and y=1 represents the top position:

$$x = \frac{\sqrt{{e}_{b} {a}_{b}}}{\sqrt{{e}_{b} {a}_{b}} + \sqrt{{e}_{t} {a}_{t}}} \qquad ( 29 )$$

where a_{b}, e_{b}, and aₜ, eₜ are the aspect ratios and areas of the bounding boxes for the bottom and top children of the interior node.

The resulting layouts of the graphic objects on the pages define the final layouts 290 of graphic objects shown in FIG. 20.

2. Detailed Process of Allocating Page Space to Graphic Objects

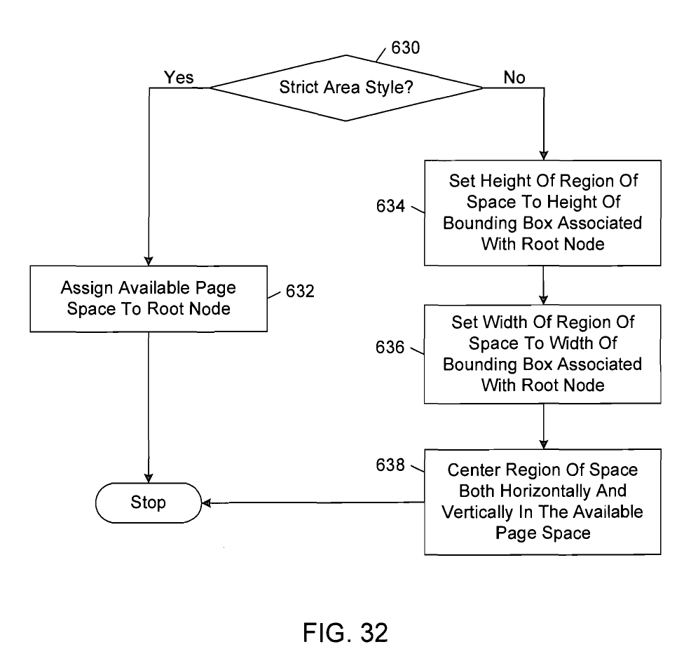

FIG. 32 shows an embodiment of a method of allocating a physical region of space on a page to the root node of the current tree structure. In accordance with this method, the layout style is determined (FIG. 32, block 630). For a strict area style layout, the entire usable area of the page is assigned to the root node (FIG. 32, block 632). For brick style layout, the page space assigned to the root node has the height and width of the bounding box associated with the root node (FIG. 32, blocks 634, 636). The region assigned to the root node then is centered in the available page space (FIG. 32, block 638).

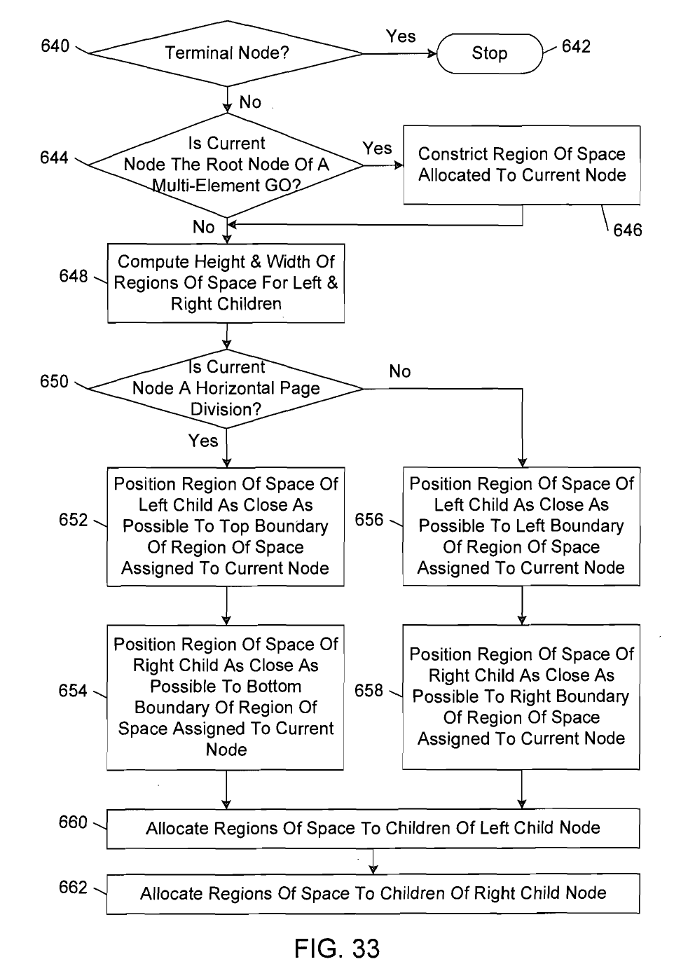

FIG. 33 shows an embodiment of a method of allocating regions of page space to children of a node of a tree structure. In this process, the region of space assigned to each interior node is divided between its two direct children. The division is accomplished by setting the root node of the current tree structure to the current node and implementing a recursive process.

In the recursive process, a decision is made whether the current node is a terminal node (FIG. 33, block 640). If the current node is terminal node (i.e., a leaf node) the process ends (FIG. 33, block 642). If the current node is an interior node, a determination is made whether the current node is the root node of a tree corresponding to a multi-element graphic object (GO) having more than one single-element graphic object (FIG. 33, block 644). If this is the case, then the region assigned to the current node is constricted (FIG. 33, block 646) by reassigning the height and width of the region to be the height and width of the bounding box previously computed for the current node, and the position of the region is centered in the region previously assigned to the current node. In brick style layout this has no effect. In strict area style layout, this has the effect of pulling together the images in a graphic assembly having more than one graphic element (such as a series of keyframes).

If it is determined that the current node is not the root node of a tree corresponding to a multi-element graphic object (FIG. 33, block 644), the height and width of the regions of space for left children and right children of the current node are computed (FIG. 33, block 648).

If the current node is a horizontal page division, the heights (H_{R}, H_{L}) of the regions assigned to the right child and the left is given by:

$$\begin{matrix}{H}_{R} = R \cdot \frac{{H}_{NODE} - S}{L + R} & ( 30 ) \\ {H}_{L} = L \cdot \frac{{H}_{NODE} - S}{L + R} & ( 31 )\end{matrix}$$

where H_{NODE} is the height of the current node region of space, S is the node spacing, L is the height of the left child node bounding box, and R is the height of the right child bounding box. The width of the regions assigned to the left and right children are set equal to the width of the region assigned to the current node.

If the current node is a vertical page division, the widths (W_{R}, W_{L}) of the regions assigned to the right child and the left is given by:

$$\begin{matrix}{W}_{R} = R \cdot \frac{{W}_{NODE} - S}{L + R} & ( 32 ) \\ {W}_{L} = L \cdot \frac{{W}_{NODE} - S}{L + R} & ( 33 )\end{matrix}$$

where W_{NODE} is the width of the current node region of space. The height of the regions assigned to the left and right children are set equal to the height of the region assigned to the current node.

If the current node is a horizontal page division (FIG. 33, block 650), the region of space of the left child is positioned as close as possible to the top boundary of the region of space assigned to the current node (FIG. 33, block 652). The region of space of the right child is positioned as close as possible to the bottom boundary of the region of space assigned to the current node (FIG. 33, block 654).

If the current node is a vertical division (FIG. 33, block 650), the region of space of the left child is positioned as close as possible to the left boundary of the region of space assigned to the current node (FIG. 33, block 656). The region of space of the right child is positioned as close as possible to the right boundary of the region of space assigned to the current node (FIG. 33, block 658).

The process described above is repeated to allocate regions of space to children of the left child node (FIG. 33, block 660) and to children of the right child node (FIG. 33, block 662). The process is repeated iteratively until regions of page space are assigned to all children (direct or otherwise) of the current node.

### VII. Conclusion

The embodiments that are described in detail herein provide ways to arrange graphic objects on one or more pages. These embodiments are capable of being guided or controlled by explicit preferences for the relative sizes of one or more of the graphic objects in each layout (or arrangement). Some embodiments leverage this feature in order to generate alternative arrangements that give special prominence to (i.e., feature) different ones of the graphic objects. In this way, these alternative arrangements provide a sampling of layouts that spans a distribution of the possible arrangements of the graphic objects on a page. Some embodiments leverage this feature to enable a user to input preferences for the relative sizes of one or more graphic objects, where the relative size preferences guide the layout generation process to emphasize (e.g., make larger) or de-emphasize (e.g., make smaller) certain ones of the graphic objects in a particular layout. In this way, users are able to guide the system to a particular layout of the graphic objects that meets the aesthetic preferences of the user, even when the user does not have a specific arrangement of the graphic objects in mind.

Other embodiments are within the scope of the claims.

What is claimed is:

1. A method of arranging graphic objects on a page, comprising:
ascertaining for each of the graphic objects a respective target rendering size of the graphic object on the page based on a respective nominal size assigned to the graphic object;
constructing different respective candidate layouts of ones of the graphic objects on the page, wherein the constructing comprises calculating respective actual rendering sizes of the graphic objects on the page in each of the candidate layouts;
determining a final layout of the graphic objects on the page based at least in part on comparisons of ones of the actual rendering sizes with respective ones of the target rendering sizes; and
outputting the final layout of graphic objects.

2. The method of claim 1, wherein the ascertaining comprises setting each of the target rendering sizes to a fraction of a total area of the page allocated for arranging the graphic objects equal to a ratio of the respective nominal size to a sum of the respective nominal sizes assigned to all the graphic objects.

3. The method of claim 1, wherein the determining comprises calculating for each of the candidate layouts a respective layout score based on degrees to which actual rendering sizes of the graphic objects in the candidate layout match the respective target rendering sizes.

4. The method of claim 3, wherein the calculating comprises for each of the candidate layouts calculating a respective graphic object score for each of the graphic objects in the candidate layout based on a ratio of the actual rendering size to the respective target rendering size and calculating the respective layout score from the respective graphic object scores.

5. The method of claim 1, wherein
the determining comprises iteratively constructing a series of successive layouts each of which comprises an additional one of the graphic objects added to the preceding layout in the series, and
in each iteration, a current one of the successive layouts is constructed from the preceding successive layout based on respective scores calculated from ones of the comparisons computed for candidate current layouts defined by different respective relative positions of the additional graphic object in the preceding successive layout.

6. A method of arranging graphic objects on a page, comprising:
determining two or more candidate assignments of respective nominal sizes to the graphic objects, wherein each of the candidate assignments is different from other ones of the candidate assignments;
constructing a respective set of one or more candidate layouts of the graphic objects on the page in accordance with each of two or more of the candidate assignments; and
outputting one or more of the candidate layouts.

7. The method of claim 6, wherein the determining comprises classifying each of the graphic objects into a respective class selected from a set of predetermined graphic object type classes, producing a sequence of the graphic objects based on the classes respectively assigned to the graphic objects, and generating the one or more candidate assignments from the sequence.

8. The method of claim 7, wherein the producing comprises selecting successive ones of the graphic objects for the sequence from ones of the graphic object type classes different from the graphic object type class from which respectively preceding ones of the graphic objects were selected.

9. The method of claim 7, wherein the generating comprises, for each of represented ones of the graphic object type classes containing at least one of the graphic objects, generating a corresponding one of the candidate assignments in which a largest one of the nominal sizes is assigned to a respective one of the graphic objects of the corresponding represented graphic object type class.

10. The method of claim 7, wherein the generating comprises generating alternative ones of the candidate assignments in which the graphic objects are assigned respective nominal sizes selected from either a first set of one or more nominal sizes or a second set of one or more nominal sizes each of which is smaller than a smallest one of the nominal sizes in the first set, and each of the alternative candidate assignments has a different number of graphic objects that are assigned nominal sizes selected from the first set of nominal sizes.

11. The method of claim 6, wherein the determining comprises, for each of respective ones of the candidate assignments, assigning respective nominal sizes selected from a first set of one or more nominal sizes to a random number of a random selection of the graphic objects, and assigning to other ones of the graphic objects respective nominal sizes selected from a second set of one or more nominal sizes each of which is smaller than a smallest one of the nominal sizes in the first set.

12. The method of claim 11, wherein the determining additionally comprises comparing a given one of the candidate assignments to one or more other ones of the candidate assignments, and discarding the given candidate assignment in response to a determination based on the comparing that the given candidate assignment is similar to any of the other candidate assignments.

13. The method of claim 12, wherein the comparing comprises classifying each of the graphic objects into a respective class selected from a set of predetermined graphic object type classes, producing for each of the given candidate assignment and the one or more other candidate assignments a respective distribution of the nominal sizes assigned to the graphic objects across the graphic object type classes.

14. The method of claim 6, wherein
the determining comprises comparing ones of the candidate assignments to each other and selecting one or more of the candidate assignments determined to be different from one another based on the comparing, and
the outputting comprises outputting respective specifications of ones of the candidate layouts corresponding to the selected ones of the candidate assignments while omitting outputting respective specifications of unselected ones of the candidate layouts.

15. A machine readable medium for arranging graphic objects on a page, the machine readable medium storing machine-readable instructions causing a machine to perform operations comprising:
ascertaining for each of the graphic objects a respective target rendering size of the graphic object on the page based on a respective nominal size assigned to the graphic object;
constructing different respective candidate layouts of ones of the graphic objects on the page, wherein the constructing comprises calculating respective actual rendering sizes of the graphic objects on the page in each of the candidate layouts;
determining a final layout of the graphic objects on the page based at least in part on comparisons of ones of the actual rendering sizes with respective ones of the target rendering sizes; and
outputting the final layout of graphic objects.

16. The machine readable medium of claim 15, wherein the machine-readable instructions cause the machine to set each of the target rendering sizes to a fraction of a total area of the page allocated for arranging the graphic objects equal to a ratio of the respective nominal size to a sum of the respective nominal sizes assigned to all the graphic objects.

17. The machine readable medium of claim 15, wherein the machine-readable instructions cause the machine to calculate for each of the candidate layouts a respective layout score based on degrees to which actual rendering sizes of the graphic objects in the candidate layout match the respective target rendering sizes.

18. A machine readable medium for arranging graphic objects on a page, the machine readable medium storing machine-readable instructions causing a machine to perform operations comprising:
determining two or more candidate assignments of respective nominal sizes to the graphic objects, wherein each of the candidate assignments is different from other ones of the candidate assignments;
constructing a respective set of one or more candidate layouts of the graphic objects on the page in accordance with each of two or more of the candidate assignments; and
outputting one or more of the candidate layouts.

19. The machine readable medium of claim 18, wherein the machine-readable instructions cause the machine to classify each of the graphic objects into a respective class selected from a set of predetermined graphic object type classes, produce a sequence of the graphic objects based on the classes respectively assigned to the graphic objects, and generate the one or more candidate assignments from the sequence.

20. The machine readable medium of claim 18, wherein, for each of respective ones of the candidate assignments, the machine-readable instructions cause the machine to assign respective nominal sizes selected from a first set of one or more nominal sizes to a random number of a random selection of the graphic objects, and assign to other ones of the graphic objects respective nominal sizes selected from a second set of one or more nominal sizes each of which is smaller than a smallest one of the nominal sizes in the first set.
